(19) United States
(12) Patent Application Publication
(10) Pub. No.: US 2018/0096376 A1
(43) Pub. Date: Apr. 5, 2018

(54) REAL-TIME ELECTRONIC DISPLAY DEVICE AND SYSTEM

(71) Applicant: Robert Stephen Rogener, Rowland Heights, CA (US)

(72) Inventor: Robert Stephen Rogener, Rowland Heights, CA (US)

(21) Appl. No.: 15/835,130

(22) Filed: Dec. 7, 2017

Related U.S. Application Data
(63) Continuation-in-part of application No. 13/946,305, filed on Jul. 19, 2013, now abandoned.
(60) Provisional application No. 61/673,847, filed on Jul. 20, 2012.

(51) Int. Cl. G06Q 30/02; G06F 3/147

(52) U.S. Cl. CPC G06Q 30/0224; G06Q 30/0281; G06F 3/147; G06Q 30/0202; G06Q 30/0267

(57) ABSTRACT

An electronic display device (EDD) mountable on a stanchion is configured to establish wireless communication (e.g., via Bluetooth, NFC, or Wi-Fi) with a portable electronic device (PED) (e.g., a smartphone) associated with a customer and receive customer information (e.g., user credentials) identifying the customer from the PED via the established communication. The EDD is further configured to retrieve a customer footprint (e.g., activity history) associated with the customer based on the customer information and retrieve one or more industry-specific variables (e.g., values of metrics). The EDD is also configured to generate an offer (e.g., a discount) for the customer based on the customer footprint and industry-specific variables. In other examples, a processing system is configured to generate the offer based on various parameters (e.g., time, number, or order) associated with multiple EDDs that define a waiting queue establishing wireless communication with the PED (e.g., as the customer traverses the queue).

### CROSS-REFERENCE TO RELATED APPLICATIONS

This application is a continuation-in-part of U.S. patent application Ser. No. 13/946,305 filed Jul. 19, 2013.

### TECHNICAL FIELD

The present disclosure relates to electronic displays, and more specifically to a real-time electronic display device that is portable and mountable on a stanchion and that can provide immediate information that may be useful to a customer.

### BACKGROUND

There are numerous electronic displays used currently, from those deployed at gas stations to those available at grocery stores. Many of these electronic displays and associated systems are designed to provide remote access for their operators to change displayed content, such as prices and other information. However, many of these electronic displays and systems are static and immobile (e.g., deployed at a fixed location). For example, the “Qthru” technology provides supermarket shoppers with a way to use their cellphones to calculate how much money they have spent and what quantities of items they have purchased, or are going to purchase, by displaying QR codes electronically when the shoppers are located next to various products. While useful, this technology is limited to providing a static electronic replacement for traditional printed signs, albeit at a higher price. Other technologies provide various other types of information to customers when the customers are located at kiosks or other fixed locations.

Moreover, in many situations and settings, it is not possible or practicable to have static electronic displays available to provide information to customers regarding real-time events. Examples of such situations and settings include airport and car rental check-in queues, which are dynamic and change many times during the course of the day. The currently-available static electronic displays are useful and effective if placed where customers can see them at all times. In the situations and settings described above, this constraint requires many more and/or larger static electronic displays, or signs, which are associated with a high implementation cost. Additionally, these static electronic displays, or signs, provide a limited amount of information to the customers and do not provide companies deploying the displays or signs with dashboard metrics.

Therefore, there is a need for a real-time electronic display device that is portable and mountable on a stanchion and that can provide immediate information that may be useful to a customer and provide a company with dashboard metrics.

### SUMMARY

In general, the techniques of the present disclosure are directed to generating and displaying information to users via electronic display devices (EDDs). In particular, this disclosure describes techniques for providing real-time information to a customer via one or more EDDs that are each mountable on a stanchion. In one example, a method for providing real-time information to a customer via an EDD mountable on a stanchion includes establishing, using the EDD, wireless communication with a portable electronic device (PED) associated with the customer and receiving, at the EDD, customer information identifying the customer from the PED via the established wireless communication. The method further includes retrieving, using the EDD, a customer footprint associated with the customer based on the customer information and retrieving, using the EDD, one or more industry-specific variables. The method also includes generating, using the EDD, an offer for the customer based on the customer footprint and one or more industry-specific variables.

In another example, a method for providing real-time information to a customer includes receiving, at a computing device, an indication of each of a plurality of EDDs establishing wireless communication with a PED associated with the customer. In this example, each of the plurality of EDDs is mountable on a stanchion, the plurality of EDDs is associated with a place of business providing one or more of a product and a service, and the plurality of EDDs defines a waiting queue for the place of business. The method also includes generating, using the computing device, an offer for the customer based on each of the plurality of EDDs establishing the wireless communication with the PED.

In another example, an EDD mountable on a stanchion and configured to provide real-time information to a customer includes a network interface component (NIC) configured to establish wireless communication with a PED associated with the customer, an input/output component (IOC) configured to receive customer information identifying the customer from the PED via the established wireless communication, retrieve a customer footprint associated with the customer based on the customer information, and retrieve one or more industry-specific variables, and an offer generation module (OGM) configured to generate an offer for the customer based on the customer footprint and the industry-specific variables. In this example, the EDD further includes one or more memory components configured to store computer-readable instructions and one or more processing units configured to execute the computer-readable instructions. The computer-readable instructions, when executed by the processing units, cause the processing units to establish, using the NIC, the wireless communication with the PED, receive, using the IOC, the customer information from the PED via the established wireless communication, retrieve, using the IOC, the customer footprint based on the customer information, retrieve, using the IOC, the industry-specific variables, and generate, using the OGM, the offer based on the customer footprint and the industry-specific variables.

In another example, a computing device configured to provide real-time information to a customer includes an IOC configured to receive an indication of each of a plurality of EDDs establishing wireless communication with a PED associated with the customer. In this example, each of the plurality of EDDs is mountable on a stanchion, the plurality of EDDs is associated with a place of business providing one or more of a product and a service, and the plurality of EDDs defines a waiting queue for the place of business. The computing device further includes an OGM configured to generate an offer for the customer based on each of the plurality of EDDs establishing the wireless communication with the PED. The computing device also includes one or more memory components configured to store computer-readable instructions and one or more processing units configured to execute the computer-readable instructions. In this example, the computer-readable instructions, when executed by the processing units, cause the processing units to receive, using the IOC, the indication of each of the plurality of EDDs establishing the wireless communication with the PED and generate, using the OGM, the offer based on each of the plurality of EDDs establishing the wireless communication with the PED.

This disclosure also describes a real-time EDD that is portable and mountable on a stanchion and that can provide immediate information that may be useful to a customer. In various implementations, the EDD includes a housing, a processor located inside the housing, a solar power panel connected to the housing, and a digital screen connected to the housing. The digital screen may be between 5 and 7.5 inches in diagonal length, in some examples. In various implementations, the EDD also includes one or more external speakers connected to the housing, a power line harness conduit connected to the housing, and a stanchion insert connector connected to the power line harness conduit. In some examples, a stanchion may be connected to the stanchion insert connector and a base may be connected to the stanchion opposite the stanchion insert connector. In various implementations, the EDD also includes a fragrance dispenser outlet connected to the housing.

In various implementations, the EDD is powered by a power cord and a power regulator is connected to the housing. The power regulator may be configured to convert standard electrical power to power that can be used by the EDD without overloading the EDD. Alternatively, the EDD may be powered by a battery, such as a high capacity rechargeable battery. The battery used to power the EDD may be connected to the housing.

In various implementations, one or more module cavities may be connected to the housing and one or more keyed device input modules may be connectable to the module cavities. For example, the module cavities may be configured to accept the keyed device input modules and the keyed device input modules may be configured to perform various functions controlled by the EDD. For instance, the keyed device input modules may be selected from a group including a contactless NFC reader board, an ARM-based computer, a Wi-Fi module, a Bluetooth module, a processor module, a fragrance synthesizer module, a coupon module, and a ticketing module, as some examples. In various implementations, the EDD also includes instructions executable on the processor and configured to cause the EDD to identify each of the keyed device input modules to automatically determine the functionality of the respective module and how to display information related to the module on the digital screen to be presented to the customer.

The customer may use the EDD by entering a retail store that uses wireless communications and, while in a waiting queue, establishing wireless communication with the EDD using the customer's portable electronic device (PED). In some examples, the EDD may be configured to measure a time from the establishment of the wireless communication between the customer (i.e., the PED) and the EDD and transmit information received from the customer (i.e., from the PED) at the EDD, using standard communications techniques, to a processing system associated with company dashboard metrics. In some examples, the EDD may be configured to review one or more customer footprints available to the processing system to find an optimal offer available for the customer based on previous customer data (e.g., the customer's footprint) associated with the customer, and compare industry-specific variables related to offerings with the previous customer data. For example the industry-specific variables related to offerings may include any of fleet availability, weather and roadway information, seat utilization and baggage capacity, and excess inventory and profit margins. Using this information, the EDD may be configured to determine an optimal offer for the customer and generate a personalized offer (e.g., an advertisement) for the customer using an offer management module. The EDD may also be configured to present a customer value proposition, i.e., the offer, to the customer's PED and the customer may redeem the customer value proposition upon exiting the waiting queue.

In various implementations, the customer's footprint may include a walk-in, a web-based or mobile application (app), a website or social media, a mobile website, a tablet, an 800 number, a promotion code, a third party website affiliate, and a loyalty program. In various implementations, the previous customer data may more generally include purchase history, loyalty program, and other relevant historical data. In various implementations, the offers presented to the customer may include upgrade offers, discount offers, personalized offers, social interactions, branded sweepstakes, dynamic and digital coupons, local offers, traditional coupons, video downloads, surveys, important notices, messages, app downloads, branded game download, and scent offerings.

The techniques described herein may be used by either a customer or a company by providing a real-time EDD, transmitting customer information from a processing system to the EDD and to a customer's PED, and transmitting information gathered from the customer from the EDD to the processing system for processing and displaying dashboard metrics. The EDD may be configured to determine pertinent offers and other information based on the received customer information and transmit the pertinent offers and other information to the customer (i.e., the PED), which may enable the customer to interactively select products and other items of interest while waiting to be served. In some examples, the EDD may also include a computing module for executing instructions to perform the above-described techniques in their entirety without using the processing system.

In various implementations, the EDD may be configured to provide information that may be useful to a customer by establishing wireless communication with the customer's PED and storing a customer ID and a device ID to track the PED through a waiting queue. For example, the EDD may be configured to send a request to the PED for input from the customer regarding offers, request the customer's interest input, and then combine the input with a company's dashboard metrics. The EDD may then stream appropriate offer information and waiting queue information to the PED. The EDD may also be configured to determine if the PED (i.e., the customer) is still in the waiting queue by tracking the customer ID and the device ID to determine a location of the PED in the queue. Upon determining that the PED is still in the waiting queue, the EDD may be configured to present additional offers while the PED is still in the queue, store in a storage location the customer ID and any information provided by the customer, and further data mine the stored information. Alternatively, the EDD may be configured to stream waiting queue information to the customer and store time metrics for data mining.

The details of one or more examples consistent with the techniques of the present disclosure are set forth in the description provided below and in the accompanying drawings. Other features, objects, and advantages of the techniques described herein will be apparent from the description and drawings, and from the claims also set forth below.

### BRIEF DESCRIPTION OF DRAWINGS

These and other features, aspects, and advantages of the present disclosure will become better understood with regard to the following description, appended claims, and accompanying figures, where:

FIG. 1 is a front isometric view of a real-time electronic display device (EDD) that is portable and mountable on a stanchion and that can provide immediate information that may be useful to a customer, according to one embodiment;

FIG. 2 is a rear isometric view of the EDD of FIG. 1;

FIG. 3 is a top view of the EDD of FIG. 1;

FIG. 4 is a front view of the EDD of FIG. 1;

FIG. 5 is a rear view of the EDD of FIG. 1;

FIG. 6 is a front view of a stanchion that may be used with the EDD of FIG. 1;

FIG. 7 is a bottom view of a base that may be used with the EDD of FIG. 1;

FIG. 8 is a top view of a base that may be used with the EDD of FIG. 1;

FIG. 9 is a flow diagram of an example method performed by the EDD of FIG. 1, according to one embodiment;

FIGS. 10A-10B illustrate example environments including multiple ones of the EDD of FIG. 1 defining a waiting queue for customers at a place of business and a customer traversing the waiting queue, according to one embodiment;

FIG. 11 is a flow diagram of another example method performed by the EDD of FIG. 1, according to one embodiment;

FIG. 12 is a functional block diagram of an example computing device that may be used to implement an EDD and/or a processing system of this disclosure;

FIG. 13 is a flow diagram of an example method performed by an EDD, consistent with the techniques of this disclosure;

FIGS. 14A-14B are flow diagrams of example methods performed by a processing system, consistent with the techniques of this disclosure;

FIG. 15 is a flow diagram of an example method performed by multiple EDDs and a processing system, consistent with the techniques of this disclosure; and

FIGS. 16A-16C are flow diagrams of additional example methods performed by multiple EDDs and a processing system, consistent with the techniques of this disclosure.

### DETAILED DESCRIPTION

In general, the techniques of the present disclosure are directed to generating and displaying information to users via electronic display devices (EDDs). In particular, this disclosure describes techniques for providing real-time information to a customer via an EDD that is mountable on a stanchion. In various implementations, the EDD mountable on the stanchion, along with one or more identical or similar devices (e.g., EDDs) each also mountable on a stanchion, defines a waiting queue for customers at a particular place of business providing any combination of one or more products and services (e.g., a sales counter, a kiosk, a help desk, etc.). In these implementations, the customer is located within the waiting queue and proximate to the EDD (e.g., as the customer traverses the queue).

In various implementations, the EDD is configured to establish wireless communication with a portable electronic device (PED) associated with the customer (e.g., the customer's cellular telephone, tablet computer, smart watch, or another mobile computing device). For example, the EDD may establish the wireless communication with the customer's PED via any of Bluetooth, NFC, and or using any number of other wireless communication protocols or interfaces. The EDD is further configured to receive customer information identifying the customer from the PED via the established wireless communication. For example, the customer information may include any identifying information, which may include the customer's activity history (e.g., purchase history, or activity related to a loyalty program) associated with the customer that identifies the customer and is accessible by the PED. In some implementations, the customer information is associated with the particular place of business associated with the waiting queue and/or a specific product or service provided by the place of business. For example, the customer information may indicate the customer's user credentials (e.g., a username and/or a password) for a software application (hereinafter, “app”) associated with one or more of the product, service, and place of business. For instance, the customer may have installed the app on the customer's PED, or accessed the app via a web-browser app or cloud-based techniques using the PED, prior to entering the waiting queue as described herein.

The EDD is further configured to retrieve a customer footprint associated with the customer based on the customer information. For example, the customer footprint may include various types of data indicating any of a so-called “walk-in” action by the customer, a mobile app used by the customer, a desktop or mobile website or a social media service accessed by the customer, a cellular telephone, tablet, smart watch, or another mobile computing device used by the customer, an 800 number dialed by the customer, a promotion code redeemed by the customer, and a third party website affiliate or loyalty program associated with the customer, any of which may be accessible by the EDD. In some implementations, the customer footprint is associated with the product or service provided by the place of business associated with the waiting queue. For example, the customer footprint may indicate previous activity by the customer with respect to one or more of the product, service, and place of business. For instance, the customer footprint may indicate a history of the customer's actions (e.g., purchases, reservations, social media posts, etc.) performed using the app associated with the product, service, and/or place of business.

The EDD is further configured to retrieve one or more industry-specific variables. For example, the industry-specific variables may include data indicating values of one or more metrics associated with a particular industry, such as any of availability of vehicles within a vehicle fleet, weather conditions, roadway conditions, roadway usage or congestion, vehicle or airplane seat utilization, vehicle or airplane baggage capacity, excess inventory, and profit margins, as some examples. In some implementations, the industry-specific variables are associated with the product or service provided by the place of business associated with the waiting queue. For instance, in examples where the waiting queue is associated with an automobile rental agency, the industry-specific variables may include data indicating a number of, descriptions of and/or other parameters associated with automobiles within the agency's vehicle fleet that are available to be rented by customers.

The EDD is also configured to generate an offer for the customer based on the customer footprint and based on the industry-specific variables. For example, the offer may include any of an upgrade offer, discount offer, local offer, personalized offer, social interaction offer, branded sweepstakes offer, traditional coupon, dynamic digital coupon, video download, branded game download, app download, survey, notice, message, and scent offering. In some implementations, the offer is associated with the product or service provided by the place of business associated with the waiting queue. For instance, in examples where the waiting queue is associated with an automobile rental agency, the offer may include an upgrade offer, a discount offer, or another offer type associated with an automobile in the agency's vehicle fleet that may be rented by the customer.

In various implementations, the EDD is associated with a place of business providing a product and/or a service, as described herein. As described herein, the customer information may identify the customer, be accessible by the PEI), and, in some examples, be associated with the product, service, and/or place of business. In some implementations, the customer information indicates user credentials associated with the customer for the place of business. For example, the customer information may indicate an account name, an account number, and/or another identifier indicating an account associated with the customer for the place of business. In some implementations, the user credentials include user log-in credentials (e.g., a username, a password, and/or a device ID) associated with the customer for an app associated with the place of business. For example, the PED may be configured to enable the customer to access the app using the user log-in credentials. As one example, the app may be a so-called “native” app configured to be installed on a computing device In this example, the PED may include the app installed thereon, thereby enabling the customer to directly access the app using the user log-in credentials. As another example, the app may be a so-called “web-based” app configured to be accessed via a web-browser app of a computing device. In this example, the PED may include a web-browser app installed thereon, thereby enabling the customer to access the app via the web-browser app using the user log-in credentials. As still another example, the app may be a so-called “cloud based” app configured to be accessed via a general or dedicated user interface (UI) of a computing device. In this example, the PED may provide the UI to the customer, thereby enabling the customer to access the app via the 0I using the user log-in credentials.

In some implementations, the customer footprint indicates previous activity associated with the product and/or service by the customer. For example, the customer footprint may indicate previous orders, reservations, and/or purchases made by the customer with respect to the product, service, and/or place of business. In some implementations, the previous activity includes previous activity associated with the product and/or service by the customer within the app associated with the place of business. For example, the customer footprint may indicate previous orders, reservations, and/or purchases made by the customer with respect to the product, service, and/or place of business within the app. In some implementations, the EDD is configured to retrieve the customer footprint using the customer information from a local data storage device (e.g., an internal or attached memory device). Additionally, or alternatively, in some implementations, to retrieve the customer footprint based on the customer information, the EDD is configured to transmit the customer information to a processing system and receive the customer footprint from the processing system in response to transmitting the customer information. For example, the processing system may be associated with the product, service, and/or place of business. For instance, the processing system may be located proximate to the EDD (e.g., at the end of the waiting queue) or remotely from the EDD (e.g., at another location). In some examples, the processing system may include one or more computing devices (e.g., servers) configured to receive, process, store, and transmit information. In this manner, the EDD may retrieve at least a part of the customer footprint based on the customer information from any combination of a local data storage device and a stand-alone processing system. Furthermore, in some implementations, to retrieve the customer footprint based on the customer information, the EDD is configured to generate, based on the customer information, a request configured to cause the PED to extract the customer footprint from the app associated with the place of business, transmit the request to the PED via the established wireless communication, and receive the customer footprint from the PED in response to transmitting the request. In this manner, the EDD may retrieve at least a part of the customer footprint based on the customer information from the app associated with the place of business (e.g., from a cache memory location associated with the app) using the MD.

In some implementations, the industry-specific variables include one or more parameters associated with the product and/or service. For example, in some implementations, the parameters include one or more values of one or more metrics associated with the product and/or service. For instance, the industry-specific variables may indicate numeric quantities and/or logic values quantifying or describing states of various parameters or attributes associated with the product and/or service provided by the place business. For example, the industry-specific variables may indicate an amount of inventory or availability of the product, a number or availability of providers of the service, and/or other values of metrics associated with the product and/or service for the place of business. In some implementations, the EDD is configured to retrieve the industry-specific variables from a local data storage device, in a similar manner as described with reference to the customer footprint. Additionally, or alternatively, in some implementations, the EDD is configured to transmit a request to a processing system and receive the industry-specific variables from the processing system in response to transmitting the request, also in a similar manner as described with reference to the customer footprint. As described herein, the processing system may be associated with the product, service, and/or place of business, may be located proximate to or remotely from the EDD, and may include one or more computing devices configured to receive, process, store, and transmit information. In this manner, the EDD may retrieve at least a part of the industry-specific variables from any combination of a local data storage device and a stand-alone processing system.

In some implementations, the EDD is further configured to determine a time (e.g., a timestamp) associated with the EDD establishing the wireless communication with the PED. In these implementations, to generate the offer, the EDD is also configured to generate the offer based on the time associated with establishing the wireless communication with the PED. In this manner, the EDD may be configured to generate or refrain from generating an offer, or generate different offers for the customer depending on the time (e.g., a time of day) at which the EDD establishes the wireless communication with the PED.

In various implementations, a plurality of EDDs each mountable on a stanchiow including the EDD, is associated with the place of business and defines a waiting queue for customers at the place of business, as described herein. In these implementations, the EDD may be further configured to generate the offer for the customer based on one or more parameters associated with the plurality of EDDs. In some implementations, the EDD is configured to determine a time (e.g., a timestamp) associated with each of multiple ones of the plurality of EDDs establishing wireless communication with the PED. For example, each of one or more of the plurality of EDDs may establish wireless communication with the PED in a similar manner as described with reference to the EDD. In these implementations, the EDD is further configured to generate the offer based on the times. As an example, the EDD may be configured to determine a difference between the time associated with a first one of the multiple ones of the plurality of EDDs establishing the wireless communication with the PED and the time associated with a second, different one of the multiple ones of the plurality of EDDs establishing the wireless communication with the PED. In this example, the EDD may be further configured to generate the offer based on the difference. In some examples, the EDD may be configured to compare the difference to a predetermined threshold difference and generate the offer based a result of the comparing the difference to the threshold difference. For example, the first one of the multiple ones of the plurality of EDDs may be first among the plurality of EDDs to establish the wireless communication with the PED and the second one of the multiples ones of the plurality of EDDs may be last among the plurality of EDDs to establish the wireless communication with the PED. Thus, the EDD may generate or refrain from generating an offer, or generate different offers based on differences between times associated with the plurality of EDDs establishing wireless communication with the PED. In some examples, the differences may represent, or be a proxy for, an amount of time the customer spends in the waiting queue. In other examples, the differences may represent a distance the customer traverses in the waiting queue (e.g., assuming an average customer speed). In still other examples, the differences may represent a speed (e.g., assuming an equal EDD spacing) or acceleration (e.g., using multiple differences) at which the customer traverses the waiting queue.

In other implementations, the EDD is configured to determine a number (e.g., one or more) of the plurality of EDDs establishing wireless communication with the PED. In these implementations, the EDD is further configured to generate the offer based on the number. As an example, the EDD may be configured to compare the number to a predetermined threshold number and generate the offer based a result of the comparing the number to the threshold number. Thus, the EDD may generate or refrain from generating an offer, or generate different offers, for the customer based on a number of the plurality of EDDs establishing wireless communication with the PED. In some examples, the number may represent, or be a proxy for, an amount of time the customer spends in the waiting queue or a distance the customer traverses in the waiting queue (e.g., assuming equal EDD spacing and/or an average customer speed).

In still other implementations, the EDD is configured to determine an order (e.g., a temporal and/or sequential order) associated with multiple ones of the plurality of EDDs establishing wireless communication with the PED. In these implementations, the EDD is further configured to generate the offer based on the order. As an example, the EDD may be configured to compare the order to a predetermined reference order (e.g., an order in which the multiple ones of the plurality of EDDs are spatially arranged to define the waiting queue) and generate the offer based a result of the comparing the order to the reference order. For example, the EDD may generate the offer based on whether and/or how closely the order matches the reference order. As one example, the EDD may, upon determining that the order and the reference order match, determine that the customer completely traversed the waiting queue and generate the offer. As another example, the EDD may, upon determining that the order and the reference order do not match, determine that the customer did not completely traverse the waiting queue (e.g., skipped in line) and refrain from generating the offer. As still another example, the EDD may, upon determining that the order and the reference order do not substantially match, determine that the customer did not completely traverse the waiting queue and generate a different offer. In some examples, to determine the order, the EDD may be configured to determine a time (e.g., a timestamp) associated with each of the multiple ones of the plurality of EDDs establishing the wireless communication with the PED and determine the order based on the times (e.g., based on a chronological progression of the times). In other examples, to determine the order, the EDD may be configured to receive an indication (e.g., an event flag) of each of the multiple ones of the plurality of EDDs establishing the wireless communication with the PED and determine the order based on the indications (e.g., based on a chronological order in which the EDD received the indications). Thus, the EDD may generate or refrain from generating an offer, or generate different offers, for the customer based on an order associated with multiple ones of the plurality of EDDs establishing wireless communication with the PED. In some examples, the order may represent, or be a proxy for, an amount of time the customer spends in the waiting queue or a distance the customer traverses in the waiting queue (e.g., assuming equal EDD spacing and/or an average customer speed).

In some implementations, the EDD is further configured to display offer information associated with the offer and configured to prompt the customer to provide a customer input to the EDD. In these implementations, the EDD is configured to receive the customer input from the customer in response to displaying the offer information and generate the offer based on the customer input. Additionally, or alternatively, in some implementations, the EDD is further configured to transmit the offer information to the PED via the established wireless communication, receive the customer input from the PED via the established wireless communication in response to transmitting the offer information, and generate the offer based on the customer input. In some examples, the offer information is further configured to be displayed to the customer at the PED via the app associated with the place of business. For example, the offer information may prompt the customer to provide the customer input to indicate interest in the offer, to accept the offer or terms of the offer, or to provide other information used by the EDD to generate the offer.

In some implementations, the EDD is further configured to display an indication of the offer to the customer (e.g., at a display of the EDD). Additionally, or alternatively, in some implementations, the EDD is further configured to transmit the indication to the PED via the established wireless communication for display to the customer (e.g., at a display of the PED). In some examples, the indication is configured to be displayed to the customer at the PED via the app associated with the place of business. In other implementations, the EDD is further configured to transmit the indication to another computing device for display to the customer (e.g., the processing system located at the end of the waiting queue). For example, the EDD may transmit the indication to the other computing device via wireless communication or other (e.g., wired) communication protocols or interfaces. In this manner, the EDD may display an indication of the offer to the customer directly, via the PED, and/or via another computing device.

In some implementations, to generate the offer, the EDD is configured to release a fragrance in proximity to the EDD and thus the customer. For example, in some implementations, the EDD is configured to select one of a plurality of fragrances included in the EDD (e.g., in a fragrance module of the EDD) based on one or more of the customer footprint and the industry-specific variables. For instance, the EDD may be configured to select a fragrance among the plurality of fragrances based on one or more aspects of the customer information and, in some examples, based on one or more of the industry-specific variables. In these implementations, the EDD is further configured to release the selected one of the plurality of fragrances proximate to the EDD (e.g., using the fragrance module).

This disclosure also describes techniques for providing real-time information to a customer via a plurality of EDDs that are each mountable on a stanchion and that define a waiting queue for customers at a place of business providing a product and/or service. For example, the customer may be located within the waiting queue and proximate to one or more of the plurality of EDDs at any given time (e.g., as the customer traverses the queue). The techniques described herein may be implemented using an EDD system including the plurality of EDDs and a processing system. In various implementations, the processing system is configured to receive an indication of each of the plurality of EDDs establishing wireless communication with the PED associated with the customer. For example, each of one or more of the plurality of EDDs may establish wireless communication with the PED in a similar manner as described with reference to the EDD. In these implementations, the processing system is further configured to generate an offer for the customer based on each of the plurality of EDDs establishing the wireless communication with the PED.

In some implementations, the processing system is configured to determine a time associated with each of the plurality of EDDs establishing the wireless communication with the PED and generate the offer based on the times, in a similar manner as described with reference to the EDD. For example, in some implementations, the processing system is configured to determine a difference between the time associated with a first one of the plurality of EDDs establishing the wireless communication with the PED and the time associated with a second, different one of the plurality of EDDs establishing the wireless communication with the PED and generate the offer based on the difference. For instance, in some implementations, the processing system is configured to compare the difference to a predetermined threshold difference and generate the offer based on a result of comparing the difference to the threshold difference. In some implementations, the first one of the plurality of EDDs is first among the plurality of EDDs to establish the wireless communication with the PED and the second one of the plurality of EDDs is last among the plurality of EDDs to establish the wireless communication with the PED. In other implementations, the first and second ones of the plurality of EDDs are EDDs other than the first and last ones of the plurality of EDDs to establish the wireless communication with the PED. In still other implementations, the processing system is configured to determine a difference between the times associated with more than two of the plurality of EDDs establishing the wireless communication with the PED and generate the offer based on the difference.

In some implementations, the processing system is configured to determine a number of the plurality of EDDs establishing the wireless communication with the PED and generate the offer based on the number, in a similar manner as described with reference to the EDD. For example, in some implementations, the processing system is configured to compare the number to a predetermined threshold number and generate the offer based on a result of comparing the number to the threshold number.

In some implementations, the processing system is further configured to determine an order associated with the plurality of EDDs establishing the wireless communication with the PED and generate the offer based on the order, in a similar manner as described with reference to the EDD. For example, in some implementations, the processing system is configured to compare the order to a predetermined reference order and generate the offer based on a result of comparing the order to the reference order. In some implementations, to determine the order, the processing system is be configured to determine a time associated with each of the plurality of EDDs establishing the wireless communication with the PED and determine the order based on the times. Additionally, or alternatively, in some implementations, to determine the order, the processing system is be configured to receive an indication of each of the plurality of EDDs establishing the wireless communication with the PED (e.g., as the respective EDD establishes the wireless communication with the PED) and determine the order based on the indication.

In some implementations, the processing system is further configured to receive customer information identifying the customer, retrieve a customer footprint associated with the customer based on the customer information, and retrieve one or more industry-specific variables, in a similar manner as described herein with reference to the EDD. In these implementations, to generate the offer, the processing system is further configured to generate the offer based on the customer footprint and based on the industry-specific variables, also in a similar manner as described herein with reference to the EDD.

In this disclosure, the offer generated by any of the EDD and the processing system may include any combination of text and image (and, e.g., audiovisual) data that describe an advertisement (ad) for a product, service, and/or business. In some examples, the offer may be associated with one or more states of one or more web-based apps (e.g., software apps accessible from a computing device via a web browser app), or one or more native apps (e software apps installed and executed on a computing device). For example, the offer may specify one or more monetary discounts or other promotions associated with the states. In these examples, the offer may include one or more user-selectable links that, when selected by a user, direct a computing device to the states in the web-based or native apps. Also in these examples, the user-selectable links may indicate (e.g., using text and/or image data) to the user the corresponding states in the web-based or native apps. In other examples, the offer may specify monetary discounts or promotions that are not directly associated with states of web-based or native apps (e.g., offers for in-store purchases).

In this disclosure, any of customer information, customer footprint, industry-specific variables, offer, and indications may be represented as one or more human-readable and/or machine-readable data structures, including any combination of character, numeric, symbolic, binary, hexadecimal, and other data representations.

The techniques of the present disclosure overcome the limitations of the prior art by providing a real-time EDD that is portable and mountable on a stanchion and that can provide immediate information that may be useful to a customer. The disclosed techniques further overcome the limitations of the prior art by providing companies with measurable metrics within a dashboard. As can be appreciated, the techniques can enable companies to monetize captive audiences waiting in waiting queues by using emerging technologies, such as NFC, RFID, Wi-Fi, Bluetooth, QR codes, synthesized scents, dynamic ticketing, dynamic couponing, and digital video by providing real-time 2-way communication applicable to the captive audiences. However, it is understood that other, newer communications technologies can also be used with the one or more EDDs described herein. Therefore, this disclosure is made by way of example and is not intended to be limiting regarding the communications technologies used in conjunction with the one or more EDD described herein.

A system of this disclosure, including one or more instances of the EDD and, e.g., the processing system, enables customers to connect with companies, brands, retailers, and/or friends, and results in a unique and novel communication between companies and customers. While customers are in a waiting queue, they can engage with companies through the EDD using their mobile phones, tablets, or other connectable devices.

Systems, methods, and devices that implement the embodiments of the features of this disclosure will now be described with reference to the drawings. The drawings and the associated descriptions are provided to illustrate embodiments of the disclosure and not to limit the scope of the disclosure. Reference in the specification to “one embodiment” or “an embodiment” is intended to indicate that a particular feature, structure, or characteristic described in connection with the embodiment is included in at least an embodiment of the disclosure. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears, in some examples.

As used in this disclosure, except where the context requires otherwise, the term “comprise” and variations of the term, such as “comprising,” “comprises,” and “comprised,” are not intended to exclude other additives, components, integers, or steps.

In the following description, specific details are given to provide a thorough understanding of the embodiments. However, it will be understood by one of ordinary skill in the art that the embodiments may be practiced without these specific details. Well-known circuits, structures, and techniques may not be shown in detail in order to not obscure the embodiments. For example, circuits may be shown in block diagrams in order to not obscure the embodiments in unnecessary detail.

Also, it is noted that the embodiments disclosed herein may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices, and/or other machine-readable mediums for storing information. The term “machine-readable medium” includes, but is not limited to, portable or fixed storage devices, optical storage devices, wireless channels and various other mediums capable of storing, containing, or carrying instruction(s) and/or data.

Furthermore, various embodiments of this disclosure may be implemented by hardware, software, firmware, middleware, microcode, or a combination thereof. When implemented in software, firmware, middleware, or microcode, program code or code segments used to perform the necessary tasks may be stored in a machine-readable medium, such as a storage medium or other storage(s). One or more processors may perform the necessary tasks in series, concurrently, or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using suitable techniques, including memory sharing, message passing, token passing, network transmission, etc.

Various embodiments of this disclosure provide a real-time EDD that is portable and mountable on a stanchion and that can provide immediate information that may be useful to a customer, as well as a system and various methods for using one or more of the EDDs. In one embodiment, there is provided a system for one or more of the EDD. In another embodiment, there are provided executable instructions operable on a processor for operating one or more of the EDD. In still another embodiment, there is provided a method for using the system for the one or more of the EDD. The EDD, system, and methods will now be disclosed in detail.

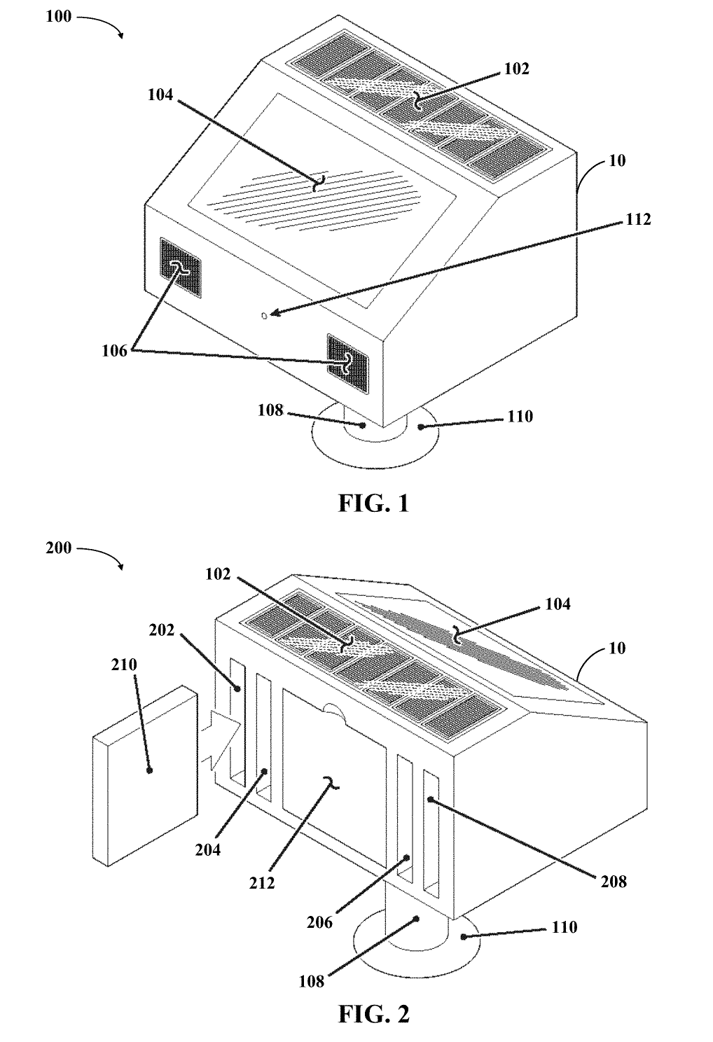

Referring now to FIG. 1, there is shown a front isometric view 100 of a real-time EDD 10 (hereinafter, “EDD 10”) that is portable and mountable on a stanchion and that can provide immediate information that may be useful to a customer, according to one embodiment. As can be seen in FIG. 1, EDD 10 includes a solar power panel 102, a digital screen (e.g., display) 104, one or more external speakers 106, a power line harness conduit 108, and a stanchion insert connector 110. As can also be seen, optionally, EDD 10 includes a fragrance dispenser outlet 112.

EDD 10 may be configured to be mounted on either stanchion base barricades or non-stanchion base barricades, depending upon the location where EDD 10 is deployed. Solar power panel 102 may be configured to provide total power to EDD 10, or to supplement a battery that is used to power EDD 10. Real-time information may be displayed on digital screen 104 and provide the customer with various communications (e.g., notifications) and ads (e.g., offers). External speaker(s) 106 may be configured to provide music, ads, or information related to what is displayed on digital screen 104. Power line harness conduit 108 may be configured to provide protective covering for power-based stanchions that receive power from a base (e.g., an outlet) or a battery. Stanchion insert connector 110 may be configured to provide connectivity between EDD 10 and a stanchion used to mount EDD 10. Fragrance dispenser 112 may be configured to provide a variety of scents that may be associated with the information displayed on digital screen 104, as described herein.

Referring now to FIG. 2, there is shown a rear isometric view 200 of EDD 10 of FIG. 1. As can be seen in FIG. 2, EDD 10 further includes a power regulator 212, one or more module cavities 202, 204, 206, and 208, and one or more keyed device input modules 210. For simplicity, only one of keyed device input module(s) 210 is shown in FIG. 2. The keyed device input module(s) 210 may be configured to be selected from a group including a contactless NFC reader board module, a processor module, a fragrance synthesizer module, a coupon module, a Wi-Fi module, a Bluetooth module, and a ticketing module, as some examples. Power regulator 212 may be configured to convert standard electrical power (e.g., 120/220 VAC) to other electrical power (e.g., 5/12/24 VDC) that can be used by EDD 10 without overloading EDD 10. The one or more module cavities 202, 204, 206, and 208 may be configured to accept keyed device input module(s) 210. Keyed device input module(s) 210, in turn, may be configured to perform various functions controlled by EDD 10. Keyed device input module(s) 210 may be configured to be inserted into EDD 10. EDD 10 may include instructions executable on a processor that cause the processor to identify each of keyed device input module(s) 210 to automatically determine the functionality of the respective one of keyed device input module(s) 210 and how to display information related to the respective one of keyed device input module(s) 210 on digital screen 104 to be presented to the customer. In some examples, EDD 10 may be configured to provide a variety of scents for patrons waiting at a cosmetics counter, print or provide digital versions of movie tickets for customers in a movie theater, or print or provide digital versions of coupons for shoppers in a grocery store. Optionally, keyed device input module(s) 210 may include a contactless NFC reader board, a Wi-Fi module, a Bluetooth module, an ARM-based computer, a fragrance synthesizer dispenser, and a coupon/ticketing module, as some examples.

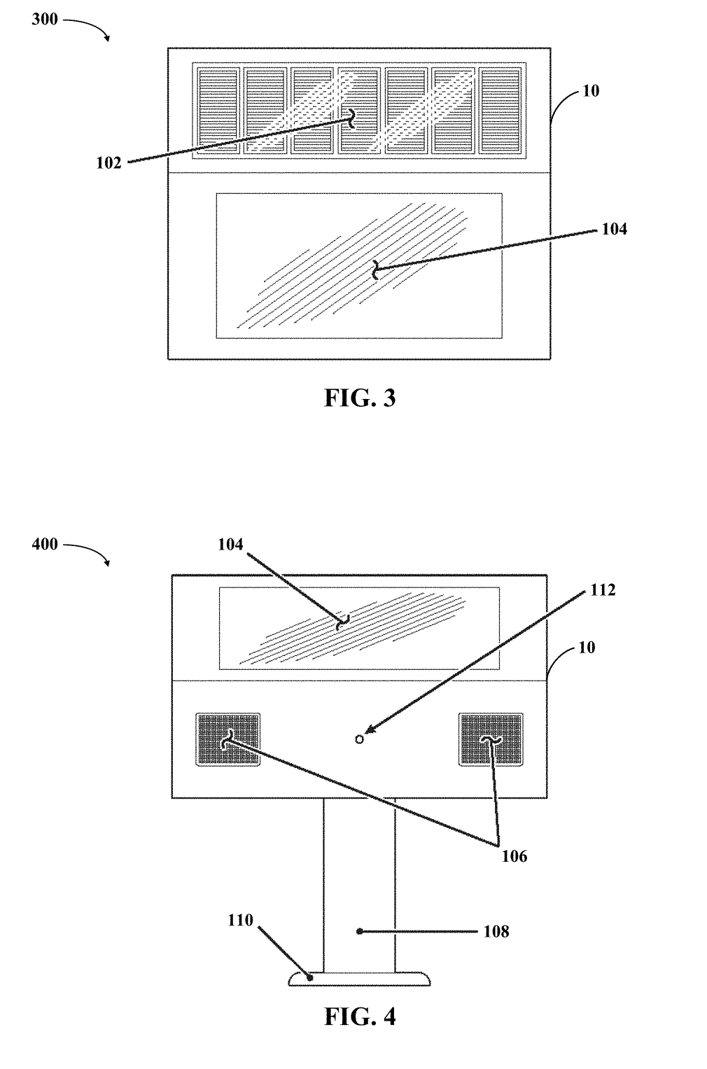

Referring now to FIG. 3, there is shown a top view 300 of EDD 10 of FIG. 1. As can be seen in FIG. 3, solar power panel 102 and digital screen 104 are visible in top view 300. In various examples, digital screen 104 is between 5 inches and 7.5 inches in diagonal length.

Referring now to FIG. 4, there is shown a front view 400 of EDD 10 of FIG. 1.

Referring now to FIG. 5, there is shown a rear view 500 of EDD 10 of FIG. 1.

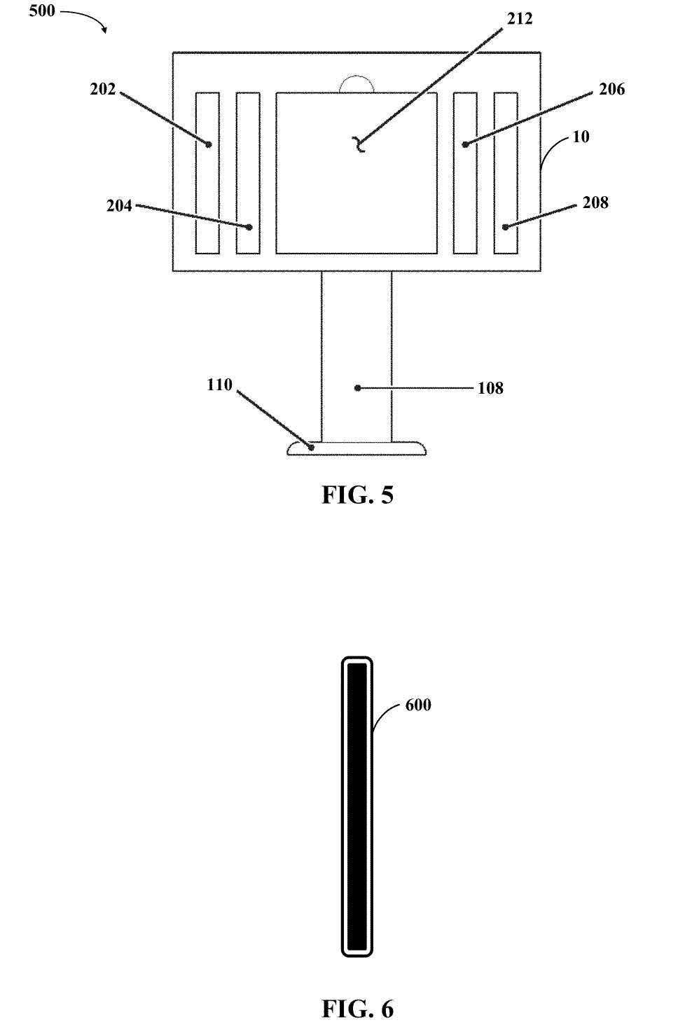

Referring now to FIG. 6, there is shown a diagram of a stanchion 600 that may be used with EDD 10 of FIG. 1. For example, stanchion 600 may be used as part of EDD 10 for routing a power cable from a stanchion base (not shown) through stanchion 600, thereby protecting the power cable from damage and potential harm to customers.

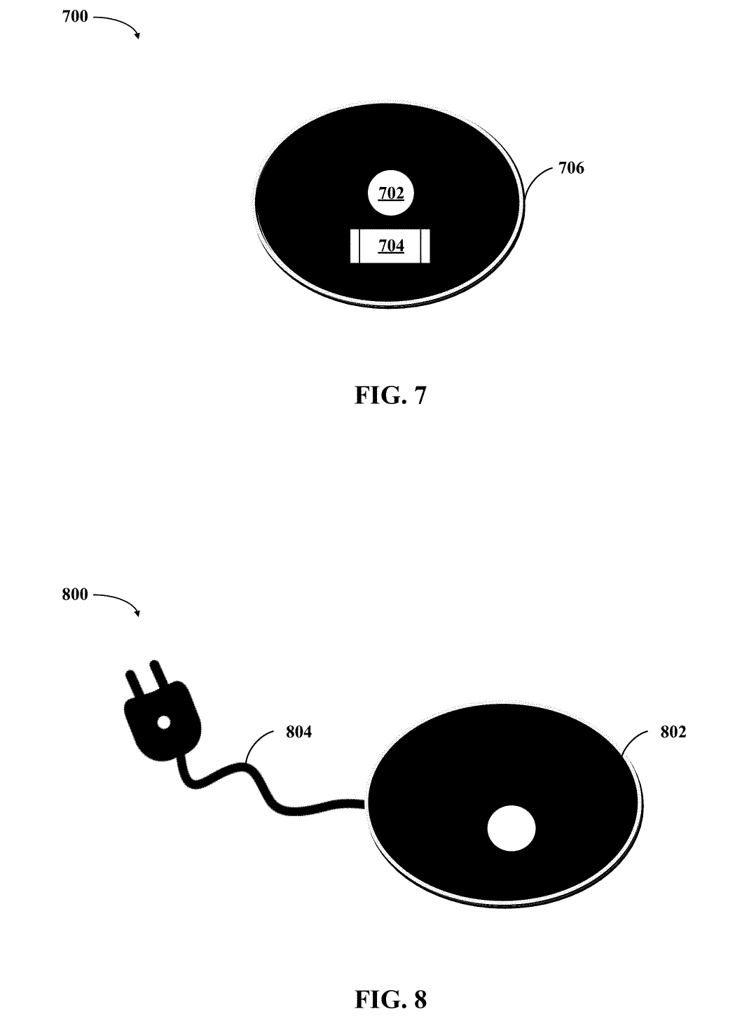

Referring now to FIG. 7, there is shown a bottom view 700 of a stanchion base 706 that may be used with EDD 10 of FIG. 1 and stanchion 600 of FIG. 6. As can be seen in FIG. 7, stanchion base 706 includes a stanchion post connector 702 and a high capacity rechargeable battery 704 (hereinafter, “battery 704”). In the example of FIG. 7, battery 704 provides ballast for EDD 10 and stanchion 600 to prevent EDD 10 and stanchion 600 from tipping over from user contact with EDD 10 and/or stanchion 600. Additionally, battery 704 may be configured to provide DC power to EDD 10 for operation. This configuration may be useful in locations that do not have ready access to AC power from an outlet, thereby rendering EDD 10 portable. In the example of FIG. 7, solar power panel 102 may be configured to supply battery 704 with recharging voltage and/or current, e.g., to recharge or extend the life of battery 704.

Referring now to FIG. 8, there is shown a top view 800 of a stanchion base 802 that may be used with EDD 10 of FIG. 1 and stanchion 600 of FIG. 6. In the example of FIG. 8, stanchion base 802 includes a power cord 804. Optionally, stanchion base 802 may include either a male voltage output connector, a female voltage input connector, or both a male and female voltage input connector. In this example, power cord 804 is configured to receive a voltage of 120 or 220 volts AC (VAC). However, EDD 10 may be configured to use any voltage source by integrating a switching power supply module (e.g., a power conversion device) into EDD 10. Such an implementation renders EDD 10 portable and usable in any country or location where a power source is readily available. Power cord 804 includes a connector that may be configured as a standard 3-prong set with an appropriate connector for a wall socket used at a particular location, or with any type of connector that is required by code at a location where EDD 10 is used.

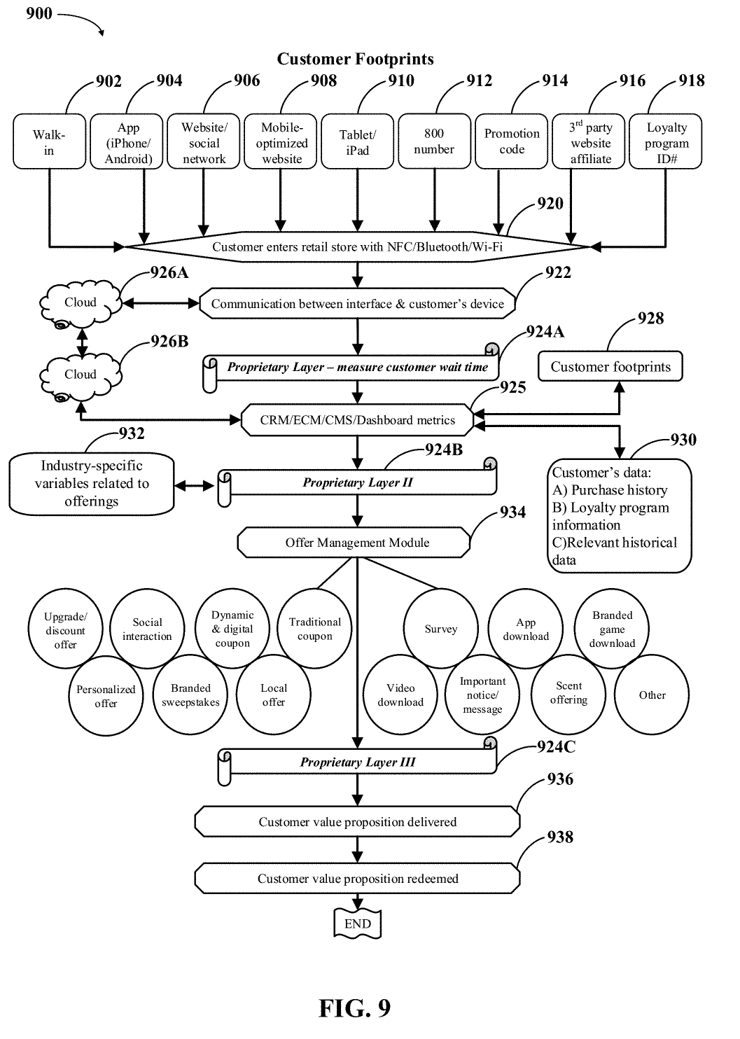

Referring now to FIG. 9, there is shown a flowchart diagram of a method 900 for using EDD 10 of FIG. 1, according to one embodiment. Initially, customer 14 (e.g., PED 12 associated with customer 14) establishes wireless communication with an interactive distribution platform implemented on EDD 10 and uses one or more methods to engage a company (e.g., associated with the platform) using one or more of customer footprints 902, 904, 906, 908, 910, 912, 914, 916 and 918. In other examples, customer 14 (e.g., via another computing device) establishes wired communication with the interactive distribution platform and uses one or more methods to engage the company using customer footprint(s) 902-918. Customer footprint(s) 902-918 may include a walk-in, a mobile app, a website, social media, a mobile website, a tablet, an 800 number, a promotion code, a third party website affiliate, and a loyalty program, among others, as described herein. In other words, customer footprint(s) 902-918 may indicate any of various actions performed by customer 14 (e.g., using PED 12 or another computing device) to interact with the interactive distribution platform associated with the company (e.g., via EDD 10, the processing system, or another computing device, such as a remote server).

Next, customer 14 enters a retail store including wireless communications, such as, e.g., Wi-Fi, NFC, or Bluetooth (920). Then, customer 14 (i.e., PED 12, or “customer's device”) establishes wireless communication with the interactive distribution platform on EDD 10 (922). In some examples, customer 14 (i.e., PED 12) further transmits customer information identifying customer 14 to EDD 10 via the established wireless communication, as described herein. Next, EDD 10 starts to measure the time from the establishment of the wireless communication between customer 14 (i.e., PED 12) and EDD 10 (“customer wait time”) (924A). Then, information received from customer 14 (i.e., from PED 12) by EDD 10 (e.g., the customer information) is transmitted from EDD 10 via standard communications techniques (e.g., via cloud communications 926A, 926B) to a CRM/ECM/CMS/dashboard metrics system 925 for processing. Next, CRM/ECM/CMS/dashboard metrics system 925 may review customer footprints 928 (e.g., a customer footprint database including multiple customer footprints) to find an optimal offer available for customer 14 based on previous customer data 930 (“customer's data”) associated with customer 14. For example, previous customer data 930 may include purchase history, loyalty program information, and relevant historical data associated with customer 14 and/or PED 12, as described herein. For instance, previous customer data 930 may include one or more of customer footprint(s) 902-918, as also described herein. Then, EDD 10 may compare one or more industry-specific variables related to offerings 932 with previous customer data 930 (924B). For example, industry-specific variables related to offerings 932 for the rental car industry may be fleet availability, or weather and roadway information; for the airline industry, industry-specific variables related to offerings 932 may be seat utilization and baggage capacity; and for clothing retailers, industry-specific variables related to offerings 932 may be excess inventory and profit margins.

Next, an offer management module 934 included in EDD 10 selects and/or generates a personalized offer to customer 14 (924C). Offer management module 934 includes instructions configured to cause EDD 10 to present customer 14 with offers based on previous customer data 930 and based on industry-specific variables related to offerings 932. The offers presented to customer 14 may include upgrade offers, discount offers, social interactions, personalized offers, branded sweepstakes, dynamic and digital coupons, local offers, traditional coupons, video downloads, surveys, important notices and messages, app downloads, branded game downloads, and scent offerings, as described herein. As can be appreciated, the presented offers may include many more offer types. Offer management module 934 may include instructions configured to cause EDD 10 to offer a superset or subset of the offers. Next, a customer value proposition, i.e., the presented offers, is delivered to PED 12 (936). Finally, upon exiting the waiting queue, customer value proposition, i.e., the presented offers, may be redeemed by customer 14 (938).

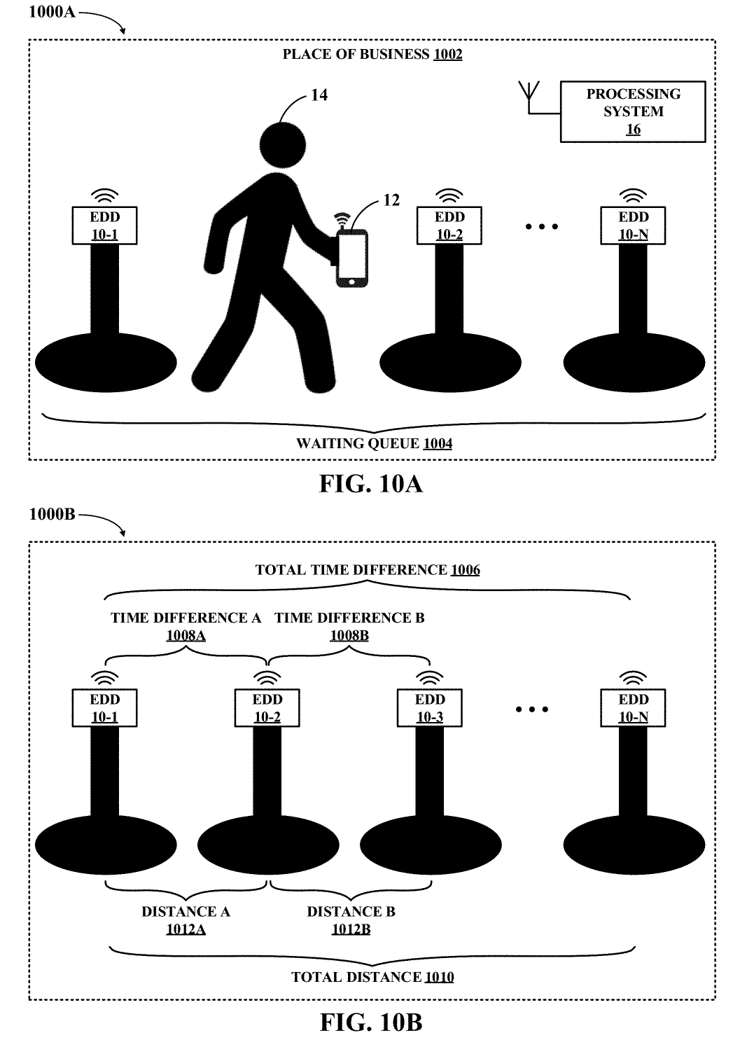

FIG. 10A depicts an example environment 1000A including a place of business 1002 providing a product and/or a service and multiple ones of EDD 10, namely EDDs 10-1 . . . 1-N (collectively, a “plurality of EDDs 20”) defining a waiting queue 1004 for the place of business 1002, as described herein. The environment 1000A also includes processing system 16 used in conjunction with the plurality of EDDs 20, as also described herein. As shown in FIG. 10A, customer 14, holding PED 12 associated with customer 14, is located within the waiting queue 1004 and proximate to one or more of the plurality of EDDs 20. In the example of FIG. 10A, customer 14 traverses the waiting queue 1004.

In the example of FIG. 10A, as customer 14 waits in the waiting queue 1004, information originating from processing system 16 (e.g., a company's central server) may be transmitted from any of the plurality of EDDs 20 to PED 12, thereby allowing communication between customer 14 (i.e., PED 12) and processing system 16. In this example, information gathered from customer 14 (i.e., from PED 12) may be transmitted from any of the plurality of EDDs 20 to processing system 16 for processing and displaying dashboard metrics. Also in this example, pertinent offers and/or other information may be transmitted from processing system 16 to customer 14 (i.e., to PED 12), and customer 14 may interactively select products or be targeted for items of interest while waiting in the waiting queue 1004. In other examples, one or more of the plurality of EDDs 20 may be configured to perform the functions attributed to processing system 16, thereby removing the need for processing system 16 and the displayed dashboard metrics.

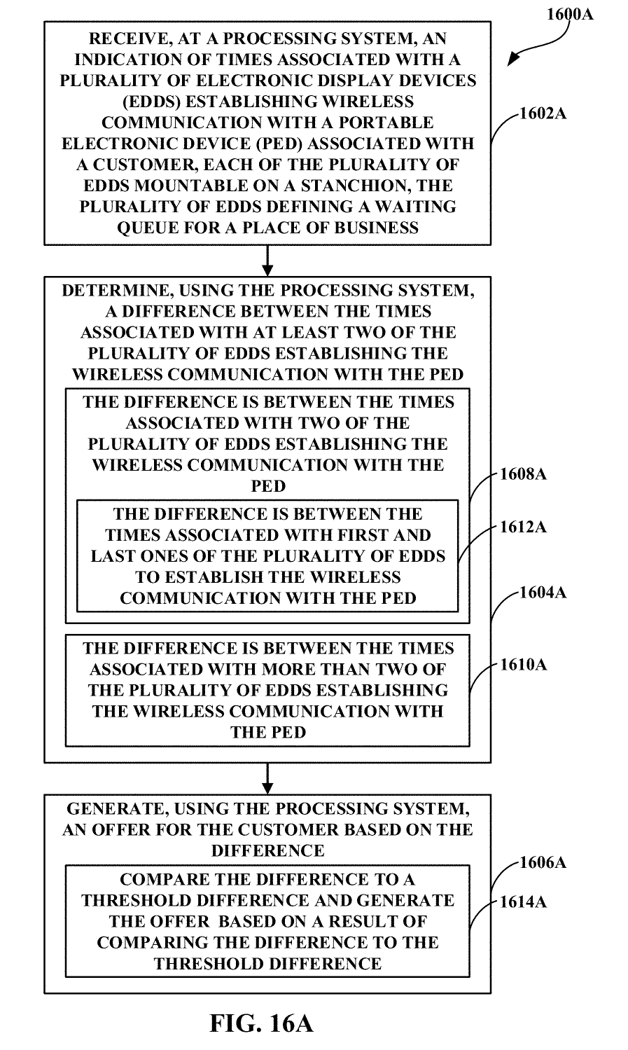

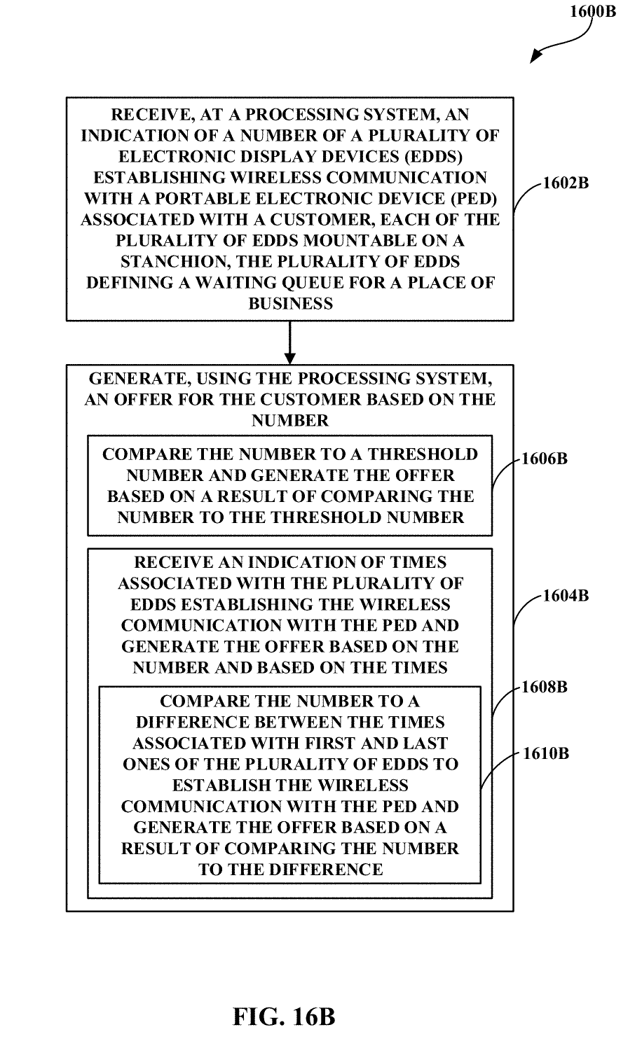

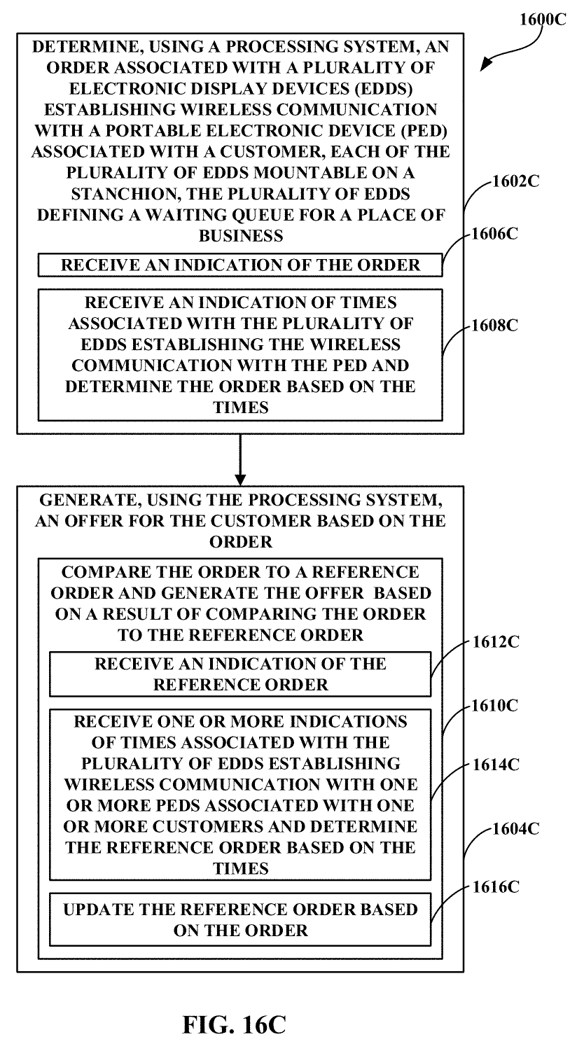

FIG. 10B depicts another example environment 1000B including the place of business 1002 and the plurality of EDDs 20 defining the waiting queue 1004 for the place of business 1002, as described with reference to FIG. 10A. The environment 1000B also includes processing system 16 used with the plurality of EDDs 20, as also described with reference to FIG. 10A. The example of FIG. 10B illustrates various parameters associated with the plurality of EDDs 20 that may be determined based on an indication of each of the plurality of EDDs 20 establishing wireless communication with PED 12 associated with customer 14, as described in greater detail with reference to FIGS. 16A-16C.

In some examples, processing system 16 receives an indication of a time (e.g., a timestamp) associated with each of the plurality of EDDs 20 establishing wireless communication with PED 12 associated with customer 14. In some examples, processing system 16 further determines a difference between the times associated with at least two of the plurality of EDDs 20 establishing the wireless communication with PED 12.

As one example, processing system 16 may determine a difference between the times associated with two of the plurality of EDDs 20 establishing the wireless communication with PED 12. For example, processing system 16 may determine a difference between the times associated with first and last ones of the plurality of EDDs 20 to establish the wireless communication with PED 12, which may be first and last, respectively, temporally and/or sequentially to establish the wireless communication with PED 12 among the plurality of EDDs 20. For instance, as shown in FIG. 10B, processing system 16 may determine a “total time difference” 1006 between the times associated with EDD 10-1 and EDD 10-N establishing the wireless communication with PED 12, which may be first and last ones of the plurality of EDDs 20 to establish the wireless communication with PED 12. As another example, processing system 16 may determine a difference between the times associated with two of the plurality of EDDs 20 establishing the wireless communication with PED 12 other than the first and last ones of the plurality of EDDs 20 to establish the wireless communication with PED 12. For example, as also shown in FIG. 10B, processing system 16 may determine a “time difference A” 1008A between the times associated with EDD 10-1 and EDD 10-2 establishing the wireless communication with PED 12. As described with reference to FIG. 16A, each of total time difference 1006 and time difference A 1008A may indicate an amount of time, distance, and/or average speed associated with customer 14 traversing at least a portion of the waiting queue 1004. As one example, in cases where a distance between EDDs 10-1 and 10-N, or “total distance” 1010, is known, total time difference 1006 may indicate an average speed at which customer 14 traverses the waiting queue 1004. For example, to determine this average speed, processing system 16 may divide total distance 1010 by total time difference 1006. Similarly, in cases where the average speed is known or assumed, total time difference 1006 may indicate total distance 1010. For example, to determine total distance 1010, processing system 16 may multiply the average speed by total time difference 1006. As another example, in cases where a distance between EDDs 10-1 and 10-2, or “distance A” 1012A, is known, time difference A 1008A may indicate an average speed at which customer 14 traverses at least a portion of the waiting queue 1004 located between EDDs 10-1 and 10-2. For example, to determine this average speed, processing system 16 may divide distance A 1012A by time difference A 1008A. Similarly, in cases where the average speed between EDDs 10-1 and 10-2 is known or assumed, time difference A 1008A may indicate distance A 1012A. For example, to determine distance A 1012A, processing system 16 may multiply the average speed between EDDs 10-1 and 10-2 by time difference A 1008A.

As another example, processing system 16 may determine a difference between the times associated with more than two of the plurality of EDDs 20 establishing the wireless communication with PED 12. For example, processing system 16 may determine a first difference between the times associated with first two of the plurality of EDDs 20 establishing the wireless communication with PED 12 and a second difference between the times associated with second two of the plurality of EDDs 20 establishing the wireless communication with PED 12. In some examples, the first and second two of the plurality of EDDs 20 may include three adjacent ones of the plurality of EDDs 20 (e.g. the first and second two of the plurality of EDDs 20 may share a common EDD). For example, as shown in FIG. 10B, processing system 16 may determine time difference A 1008A. Similarly, as also shown in FIG. 10B, processing system 16 may determine a “time difference B” 1008B between the times associated with EDD 10-2 and EDD 10-3 establishing the wireless communication with PED 12. In this example, EDDs 10-1, 10-2, and 10-3 of the plurality of EDDs 20 are adjacent in the waiting queue 1004. As described with reference to FIG. 16A, processing system 16 may aggregate or otherwise combine time differences A and B 1008A, 1008B. As also described with reference to FIG. 16A, the combined or otherwise aggregated time differences A and B 1008A, 1008B may indicate whether and to what degree customer 14 traverses the waiting queue 1004 at an increasing or decreasing speed. For example, in cases where EDDs 10-1, 10-2, and 10-3 are spaced a known and equal distance apart (i.e., distance A 1012A and a “distance B” 1012B are known and substantially equal), existence of a difference between time differences A and B 1008A, 1008B, a sign of the difference, and/or a magnitude of the difference may indicate whether customer 14 traverses the waiting queue 1004 at an increasing or decreasing speed (i.e., is accelerating or decelerating).

In other examples, processing system 16 receives an indication of a number of the plurality of EDDs 20 establishing the wireless communication with PED 12. For example, as shown in FIG. 10B, processing system 16 may receive an indication that EDDs 10-1, 10-2, and 10-3, in other words 3 of the plurality of EDDs 20, established the wireless communication with PED 12. As described with reference to FIG. 16B, the number of the plurality of EDDs 20 establishing the wireless communication with PED 12 may indicate a distance, amount of time, and/or average speed associated with customer 14 traversing at least a portion of the waiting queue 1004. As one example, in cases where EDDs 10-1, 10-2, and 10-3 are spaced a known and equal distance apart (i.e., distance A 1012A and a distance B 1012B are known and substantially equal), the number (i.e., 3) may indicate a distance that customer 14 traverses through at least a portion of the waiting queue 1004 located between EDDs 10-1 and 10-3. For example, to determine this distance, processing system 16 may multiply the number of EDDs 10-1, 10-2, and 10-3 (i.e., 3), less one to adjust for a number of spaces between EDDs 10-1, 10-2, and 10-3 (i.e., 2), by distance A 1012A or distance B 1012B. As another example, in cases where an average speed at which customer 14 traverses at least this portion of the waiting queue 1004 is known or assumed, the number (i.e., 3) may also indicate an amount of time that customer 14 uses to traverse at least this portion of the waiting queue 1004. For example, to determine this amount of time, processing system 16 may divide the distance determined using the number by the average speed. As still another example, in cases where the amount of time that customer 14 uses to traverse at least this portion of the waiting queue 1004 is known, the number (i.e., 3) may further indicate the average speed at which customer 14 traverses at least this portion of the waiting queue 1004. For example, to determine this average speed, processing system 16 may divide the distance determined using the number by a difference between the times associated with EDDs 10-1 and 10-3 establishing the wireless communication with PED 12.

In other examples, processing system 16 determines an order associated with the plurality of EDDs 20 establishing the wireless communication with PED 12. For example, as shown in FIG. 10B, processing system 16 may receive an indication that EDDs 10-1, 10-2, and 10-3 of the plurality of EDDs 20 established the wireless communication with PED 12 in the temporal and/or sequential order shown (i.e., starting with EDD 10-1, proceeding to EDD 10-2, and ending with EDD 10-3). As described with reference to FIG. 16C, the order of the plurality of EDDs 20 establishing the wireless communication with PED 12 may indicate the manner in which customer 14 traverses at least a portion of the waiting queue 1004 (e.g., whether customer 14 complies with the order). As also described with reference to FIG. 16C, processing system 16 may compare the order to a reference order, which may reflect a relative spatial arrangement of the plurality of EDDs 20 within the waiting queue 1004 and indicate a temporal and/or sequential order in which customers generally traverse, or should traverse, the waiting queue 1004.

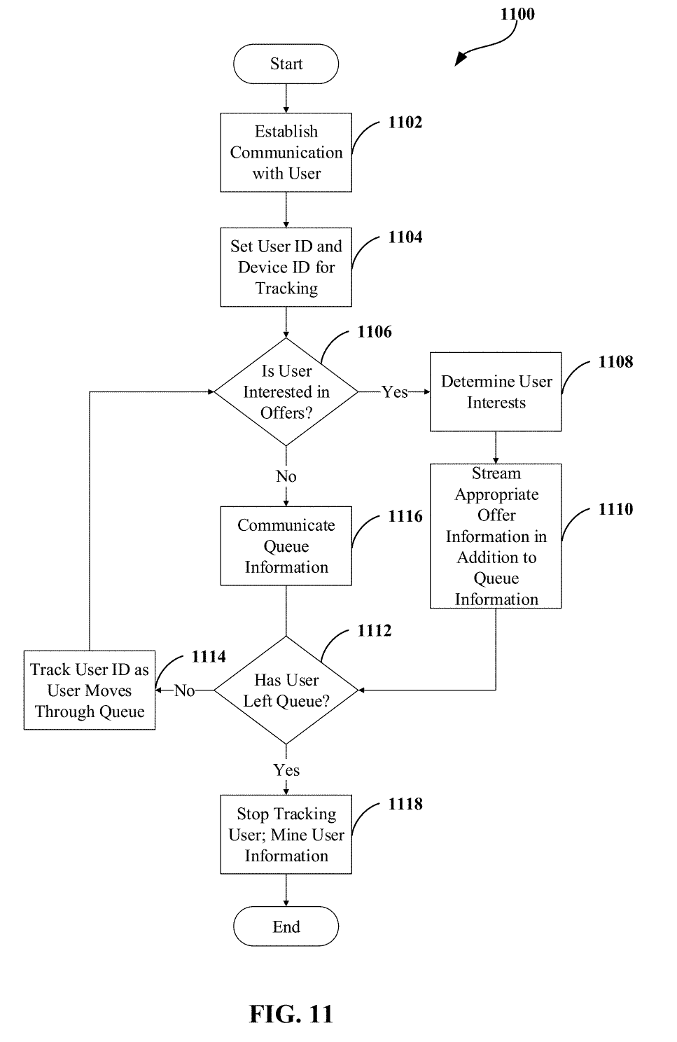

Referring now to FIG. 11, there is shown a flowchart diagram of another method 1100 for using EDD 10. First, EDD 10 establishes wireless communication with a user, e.g., customer 14 (e.g., with PED 12 associated with customer 14) located in a waiting queue (1102). Then, a user ID and a device ID are set to track the user, or customer 14, through the waiting queue (1104). For example, EDD 10 and/or processing system 16 may set the user ID and device ID to track the user, or customer 14, through the waiting queue. Next, EDD 10 determines if the user, or customer 14, is interested in offers (e.g., ads) (1106). For example, EDD 10 may send a request to the user, or customer 14 (e.g., to PED 12), or display the request to the user, or customer 14, inquiring whether the user, or customer 14, is interested in offers. Then, if EDD 10 determines that the user, or customer 14, is interested in offers (“Yes” branch of 1106), EDD 10 further determines user interests (1108). For instance, the user interests may indicate which offer types interest the user, or customer 14. For example, EDD 10 may prompt the user, or customer 14, to input or otherwise provide the user interests to EDD 10. In some examples, EDD 10 and/or processing system 16 combine the user interests with a company's dashboard metrics to personalize offer information presented to the user, or customer 14, as described herein. Next, appropriate offer information (e.g., ad content) and queue information (e.g., information relating to the waiting queue) are streamed to the user, or customer 14 (e.g., to PED 12) or displayed to the user, or customer 14 (1110). For example, EDD 10 and/or processing system 16 may stream, or EDD 10 may display, the appropriate offer information and queue information to the user, or customer 14. Then, a determination is made as to whether the user, or customer 14, has left the waiting queue or is still in the queue (1112). For example, EDD 10 and/or processing system 16 may make the determination whether the user, or customer 14, has left or is still in the waiting queue. Next, if the user, or customer 14, has not left the waiting queue (“No” branch of 1112), the user ID and, e.g., the device ID, are tracked as the user, or customer 14, moves through the waiting queue (1114) to determine where the user, or customer 14, is in the queue. For example, EDD 10 and/or processing system 16 may track the user ID and, e.g., the device ID, as the user, or customer 14, moves through the waiting queue. If the user, or customer 14, is still in the waiting queue, more offers are presented to the user, or customer 14, until the user, or customer 14, leaves the queue. Specifically, EDD 10 again determines if the user, or customer 14, is interested in offers (1106). Finally, if the user, or customer 14, has left the waiting queue (“Yes” branch of 1112), the user ID and any information given by the user, or customer 14, are stored in a storage location and the customer information is data-mined for information. Specifically, EDD 10 and/or processing system 16 stop tracking the user, or customer 14, and data-mine the user information (1118). Alternatively, if EDD 10 determines that the user, or customer 14, is not interested in offers (“No” branch of 1106), waiting queue information is communicated, e.g., streamed, to the user, or customer 14 (e.g., to PED 12) (1116). Whether EDD 10 determines that the user, or customer 14, is or is not interested in offers, however, EDD 10 and/or processing system 16 stop tracking the user, or customer 14, and data-mine the user information (1118). For instance, time metrics, such as, e.g., how long the user, or customer 14, had to wait in the waiting queue, may be stored and the associated data may be mined by EDD 10 and/or processing system 16.

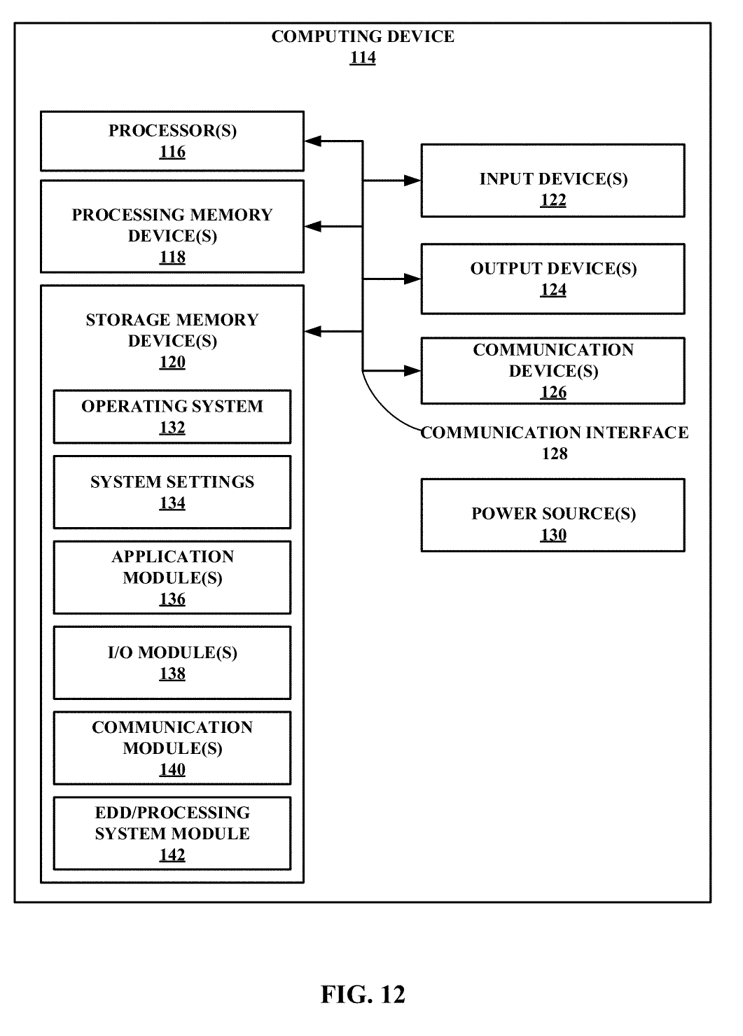

FIG. 12 is a functional block diagram of an example computing device 114 that may be used to implement one or more of EDD 10, any of the plurality of EDDs 20, and processing system 16 described with reference to FIGS. 1-11. FIG. 12 illustrates only one example of computing device 114. Many other examples of computing device 114 may be used to implement EDD 10, any of the plurality of EDDs 20, and/or processing system 16 described herein. Such other examples of computing device 114 may include a subset of the components of computing device 114 shown in FIG. 12, additional components not shown in FIG. 12, or any combination thereof. As such, the techniques of this disclosure are not limited to the example of computing device 114 depicted in FIG. 12.

As shown in FIG. 12, computing device 114 includes one or more processors 116, processing memory devices 118, storage memory devices 120, input devices 122, output devices 124, communication devices 126, and power sources 130. In the example of FIG. 12, storage memory device(s) 120 further include an operating system 132, system settings 134, one or more app modules 136 (e.g., one or more software apps installed on computing device 114), input/output (I/O) modules 138, communication modules 140, and an EDD/processing system module 142. As also shown in FIG. 12, the various components of computing device 114 are interconnected via a communication interface 128 (e.g., a system component interconnect or communication interface, such as a so-called “system bus”).

Processor(s) 116 may be configured to execute instructions within computing device 114 to implement the functionality of the techniques of this disclosure. For example, processor(s) 116 may process one or more machine-readable instructions stored in one or more of processing memory device(s) 118 and storage memory device(s) 120. Such instructions may include components of one or more of operating system 132, system settings 134, app module(s) 136, I/O module(s) 138, communication module(s) 140, and EDD/processing system module 142, and/or any other instructions.

Processing memory device(s) 118 may, in turn, include one or more devices that are intended for temporary rather than long-term data storage. Examples of such devices include volatile memory devices that may not maintain data stored therein when the devices are not receiving power. Such devices include RAM, dynamic RAM (DRAM), static RAM (SRAM), and other types of volatile memory devices known in the art. In some examples, processing memory device(s) 118 may store program instructions used for execution by processor(s) 116. For example, processing memory device(s) 118 may be used by one or more of operating system 132, system settings 134, app module(s) 136, I/O module(s) 138, communication module(s) 140, and EDD/processing system module 142 to temporarily store information, such as instructions, during program execution by processor(s) 116.

Storage memory device(s) 120 may include one or more computer-readable storage media. For example, storage memory device(s) 120 may be configured for long-term and/or short-term storage of information including, e.g., instructions, data, and other information used by computing device 114. In some examples, storage memory device(s) 120 may include non-volatile storage memory devices, such as magnetic hard disk drives (HDDs), solid state disk (SSD) drives, magnetic floppy discs, compact disc ROM (CD-ROM) discs, flash memory devices (e.g., USB drives and integrated circuit flash memories), programmable ROMs (PROM), electrically programmable ROMs (EPROMs), electrically erasable and programmable ROMs (EEPROMs), and other non-volatile storage devices.

Input device(s) 122, in conjunction with I/O module(s) 138, may be configured to receive various types of input from a user or another device, including any of tactile, contact, proximity, thermal, audio, video, or biometric inputs, or inputs in the form of one or more electrical signals, generally. Examples of input device(s) 122 include a button, touchpad, touchscreen, keyboard, mouse, microphone, still and/or video camera, fingerprint reader, retina scanner, or another device capable of receiving an input from a user or another device and relaying the input to computing device 114 or its components. For example, input device(s) 122 may include a button or a touchpad device configured to receive a pressure and/or contact input from a user. In some examples, input device(s) 122 may be configured to receive a customer input from customer 14 in response to displaying (e.g., via output device(s) 124) to customer 14 offer information associated with an offer and configured to prompt customer 14 to provide the customer input to EDD 10, as described herein.

Output device(s) 124, in conjunction with I/O module(s) 138, may be configured to provide various types of output to a user or another device, including any of visual, auditory, tactile, or other outputs, or outputs in the form of one or more electrical signals, generally. Examples of output device(s) 124 include a liquid crystal display (LCD), a light emitting diode (LED) display, or another type of display, a sound output device including a speaker element, or another device capable of generating an output that may be intelligible to a user. In some examples, output device(s) 124 may be configured to display to customer 14 offer information associated with an offer and configured to prompt customer 14 to provide a customer input to EDD 10 (e.g., via input device(s) 122), as described herein.

In some implementations, or more of input device(s) 122 and/or output device(s) 124, in conjunction with one or more of I/O module(s) 138, may form a unified transceiver device configured to both receive various types of inputs from a user and/or another computing device and transmit various types of outputs to a user and/or another computing device. In some implementations, one or more of input device(s) 122 and/or output device(s) 124, in conjunction with one or more of I/O module(s) 138, may also form a wireless data interface (e.g., a Bluetooth, NFC, or Wi-Fi radio) and/or a wired data interface (e.g., an Ethernet, fiber optic, or USB transceiver) that may be used as part of one or more of communication device(s) 126 and/or communication module(s) 140, which are described herein. For example, input device(s) 122, output device(s) 124, I/O module(s) 138, communication device(s) 126, and/or communication module(s) 140 may form an I/O component (IOC), as described in greater detail below.

In some examples, computing device 114 may use communication device(s) 126, in conjunction with communication module(s) 140, to communicate with other computing devices via one or more wired or wireless networks. For example, communication device(s) 126 may include a network interface component (NIC) or device, such as an Ethernet, optic fiber, USB, Bluetooth, NFC, Wi-Fi, or another interface card, an optical transceiver, a radio frequency (RF) transceiver, or any other device capable of receiving and/or transmitting information to facilitate exchange of information with one or more other computing devices. As one example, communication device(s) 126, in conjunction with communication module(s) 140, may be used to implement a wireless data interface (e.g., Bluetooth, NFC, or Wi-Fi) configured to transmit and/or receive data to/from another computing device. In an example where computing device 114 is used to implement EDD 10 or any of the plurality of EDDs 20, the wireless data interface may be configured to establish the wireless communication with PED 12 associated with customer 14 and receive any of the customer information from PED 12, the customer footprint from processing system 16, and the industry-specific variables from processing system 16. Additionally, or alternatively, communication device(s) 126, in conjunction with communication module(s) 140, may be used to implement a wired data interface (e.g., Ethernet, optic fiber, USB) configured to transmit and/or receive data to/from another computing device. In an example where computing device 114 is used to implement processing system 16, the wireless and/or wired data interface may be configured to receive any of the customer information and the request for the industry-specific variables from EDD 10 or any of the plurality of EDDs 20, or the indication of each of the plurality of EDDs 20 establishing the wireless communication with PED 12. As described herein, communication device(s) 126, communication module(s) 140, input device(s) 122, output device(s) 124, and/or I/O module(s) 138 may be configured to form an IOC used to implement the wireless and/or wired data interface described above.

Power source(s) 130 may include any combination of one or more power supplies or power conversion devices and components thereof capable of providing operating and/or charging power to one or more components of computing device 114. Power source(s) 130 may include any combination of battery-based, solar power-based, kinetic, thermal, or wind power-based, off-line (e.g., AC/DC), direct-current (DC/DC), switch-mode, and linear voltage regulators and/or controllers, and any associated electronic components and circuitry.

Operating system 132 may direct one or more functionalities of computing device 114 and/or its components. For example, operating system 132 may interact with any of app module(s) 136, I/O module(s) 138, communication module(s) 140, and EDD/processing system module 142, and may facilitate one or more interactions between the modules and any of processor(s) 116, input device(s) 122, output device(s) 124, and communication device(s) 126. Although not shown in FIG. 12, operating system 132 may interact with, or be otherwise coupled to, any of the modules described above, or to any components thereof. In some examples, one or more of the modules may be included within, or be otherwise provided by, operating system 132. Additionally, operating system 132 may use system settings 134 to initialize and/or update various system settings of computing device 114.

In general, EDD 10, any of the plurality of EDDs 20, and/or processing system 16 may each include any suitable arrangement of hardware, software, and/or firmware to perform the techniques attributed thereto in this disclosure. For example, although shown in FIG. 12, EDD 10, any of the plurality of EDDs 20, and/or processing system 16 may each include one or more microprocessors, microcontrollers, digital signal processors (DSPs), application specific integrated circuits (ASICs), field programmable gate arrays (FPGAs), or any other equivalent integrated or discrete logic circuitry, as well as any combination thereof. EDD 10, any of the plurality of EDDs 20, and/or processing system 16 may further include various types of analog circuitry, in addition to, or in place of, the logic devices and circuitry described above, and any number of mechanical, electro-mechanical, or structural hardware and components. Furthermore, EDD 10, any of the plurality of EDDs 20, and/or processing system 16 may include one or more program instructions used for execution by processor(s) 116 to implement the techniques described herein relating to EDD 10, any of the plurality of EDDs 20, and/or processing system 16. For example, the program instructions may, when executed by processor(s) 116, direct one or more of processor(s) 116, input device(s) 122, output device(s) 124, and communication device(s) 126 (e.g., in conjunction with processing memory device(s) 118, storage memory device(s) 120, and/or components thereof), to perform the techniques attributed to EDD 10, any of the plurality of EDDs 20, and/or processing system 16 herein.

In general, computing device 114, whether used to implement EDD 10, any of the plurality of EDDs 20, or processing system 16, may include any combination of one or more processors, including any of microprocessors, microcontrollers, DSPs, FPGAs, and ASICs. Computing device 114 may also include various storage memory devices, both static, such as HDDs, SSD drives, optical drives, and FLASH memory, and dynamic, such as RAM, DRAM, and SRAM. As such, computing device 114 may include any of hardware, software, and firmware elements, alone or in any combination, to implement the various aspects and features described in this disclosure. Thus, the techniques of this disclosure should not be limited to any particular embodiment described or depicted in this disclosure.

In this manner, FIG. 12 represents an example implementation of EDD 10, any of the plurality of EDDs 20, and/or processing system 16 described herein. In an example where computing device 114 is used to implement EDD 10 or any of the plurality of EDDs 20, computing device 114 is configured to establish, using communication device(s) 126 with communication module(s) 140, wireless communication with PED 12 associated with customer 14. Computing device 114 is further configured to receive, using communication device(s) 126 with communication module(s) 140, customer information identifying customer 14 from PED 12 via the established wireless communication. Computing device 114 is further configured to retrieve a customer footprint associated with customer 14 based on the customer information and retrieve one or more industry-specific variables. For example, computing device 114 may retrieve the customer footprint and/or industry-specific variables from one or more components of storage memory device(s) 120. Additionally, or alternatively, computing device 114 may retrieve the customer footprint and/or industry-specific variables from processing system 16 using communication device(s) 126 with communication module(s) 140. For instance, computing device 114 may transmit, using communication device(s) 126 with communication module(s) 140, the customer information to processing system 16 and receive, using communication device(s) 126 with communication module(s) 140, the customer footprint from processing system 16 in response to transmitting the customer information. Similarly, computing device 114 may transmit, using communication device(s) 126 with communication module(s) 140, a request to processing system 16 and receive, using communication device(s) 126 with communication module(s) 140, the industry-specific variables from processing system 16 in response to transmitting the request. Computing device 114 is also configured to generate, using processor(s) 116 executing instructions stored in EDD/processing system module 142, an offer for customer 14 based on the customer footprint and based on the industry-specific variables. For example, EDD/processing system module 142 may include an offer generation module (OGM) configured to generate the offer for customer 14 based on the customer footprint and based on the industry-specific variables, as described herein. In an example where computing device 114 is used to implement processing system 16, computing device 114 is configured to receive, using communication device(s) 126 with communication module(s) 140, the customer information from EDD 10 or any of the plurality of EDDs 20 and transmit, using communication device(s) 126 with communication module(s) 140, the customer footprint to EDD 10 or any of the plurality of EDDs 20 in response to receiving the customer information. Additionally, or alternatively, computing device 114 is configured to receive, using communication device(s) 126 with communication module(s) 140, the request from EDD 10 or any of the plurality of EDDs 20 and transmit, using communication device(s) 126 with communication module(s) 140, the industry-specific variables to EDD 10 or any of the plurality of EDDs 20 in response to receiving the request. In another example where computing device 114 is used to implement processing system 16, computing device 114 is configured to receive, using communication device(s) 126 with communication module(s) 140, the indication of each of the plurality of EDDs 20 establishing the wireless communication with PED 12. Computing device 114 is also configured to generate, using processor(s) 116 executing instructions stored in EDD/processing system module 142, an offer for customer 14 based on the customer footprint and based on each of the plurality of EDDs 20 establishing the wireless communication with PED 12 (e.g., using the OGM).

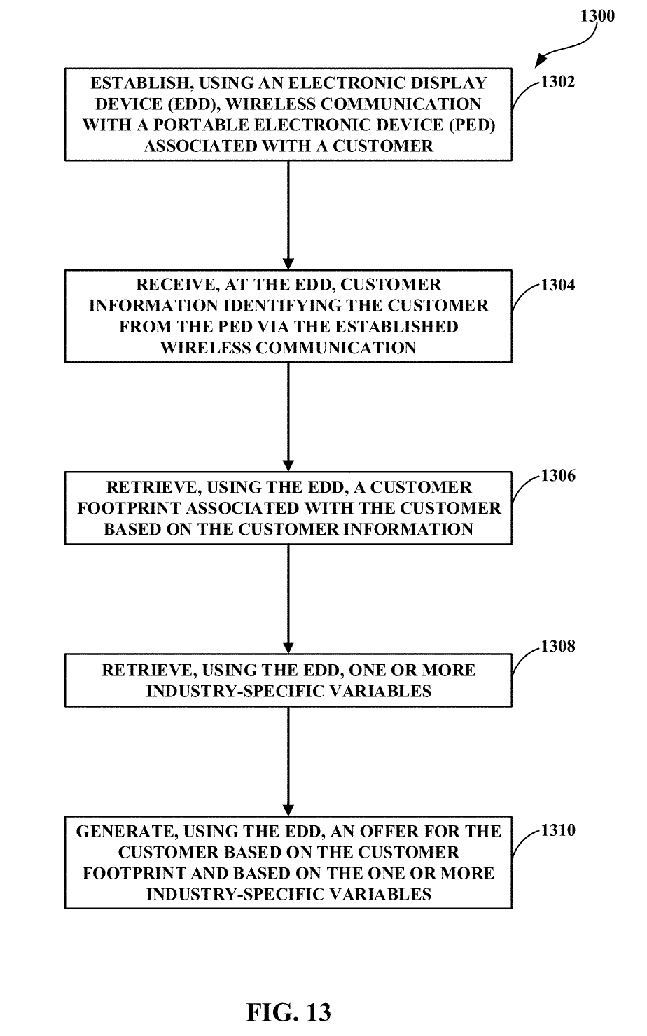

FIG. 13 depicts a flow diagram 1300, which illustrates an example interaction between EDD 10 and PED 12 associated with customer 14, as described with reference to FIGS. 1-12. In the example of FIG. 13, EDD 10 may be implemented using computing device 114 described with reference to FIG. 12. As shown in FIG. 13, initially, EDD 10 establishes wireless communication with PED 12 associated with customer 14 (1302). For example, EDD 10 may establish the wireless communication with PED 12 via any combination of Bluetooth, NFC, Wi-Fi, and another wireless communication protocol or interface, as described herein. As further shown, EDD 10 receives customer information identifying customer 14 from PED 12 via the established wireless communication (1304). For example, the customer information may identify customer 14, be accessible by PED 12, and be associated with a product, service, and/or place of business, as described herein. As still further shown, EDD 10 retrieves a customer footprint associated with customer 14 based on the customer information (1306). For example, the customer footprint may indicate previous activity by customer 14 with respect to the product, service, and/or place of business, as described herein. For instance, EDD 10 may retrieve the customer footprint from a local storage device (e.g., a local memory location), a remote storage device (e.g., a server or cloud storage location), or any combination thereof. Additionally, or alternatively, EDD 10 may retrieve the customer footprint by transmitting the customer information to processing system 16 and receiving the customer footprint from processing system 16 in response to transmitting the customer information. As still further shown, EDD 10 retrieves one or more industry-specific variables (1308). For example, the industry-specific variables may indicate values of metrics associated with the product, service, and/or place of business, as described herein. For instance, EDD 10 may retrieve the industry-specific variables from a local storage device and/or a remote storage device, in a similar manner as described with reference to the customer footprint. Additionally, or alternatively, EDD 10 may retrieve the industry-specific variables by transmitting a request to processing system 16 and receiving the industry-specific variables from processing system 16 in response to transmitting the request, also in a similar manner as described with reference to the customer footprint. As also shown, EDD 10 generates an offer for customer 14 based on the customer footprint and based on the industry-specific variables (1310). For example, the offer (e.g., an ad) may include various offer types, such as a discount, upgrade, or another offer, associated with the product, service, and/or place of business, as described herein.

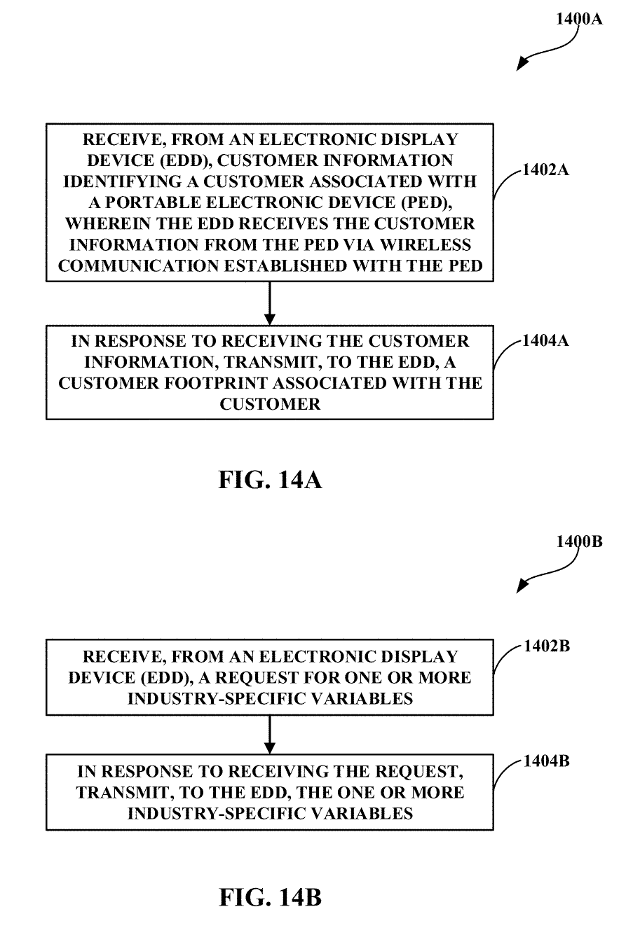

FIGS. 14A-14B depict flow diagrams 1400A, 1400B, respectively, which illustrate example interaction between EDD 10 and processing system 16, as also described with reference to FIGS. 1-12. As shown in FIG. 14A, initially, processing system 16 receives customer information identifying customer 14 associated with PED 12 from EDD 10 (1402A). For example, the customer information may identify customer 14, be accessible by PED 12, and be associated with a product, service, and/or place of business, as described herein. In this example, EDD 10 receives the customer information from PED 12 via wireless communication established with PED 12 (1402A), as described with reference to FIG. 13. For example, processing system 16 may receive the customer information from EDD 10 using any combination of wired and wireless communication protocols or interfaces, including any of Ethernet, optic fiber, USB, Bluetooth, NFC, Wi-Fi, and another wired or wireless communication protocol or interface. In the example of FIG. 14A, processing system 16 may retrieve a customer footprint associated with customer 14 based on the customer information. For example, the customer footprint may indicate previous activity by customer 14 with respect to the product, service, and/or place of business, as described herein. For instance, processing system 16 may retrieve the customer footprint from a local storage device and/or a remote storage device, in a similar manner as described with reference to FIG. 13. Additionally, or alternatively, processing system 16 may retrieve the customer footprint by transmitting the customer information to another computing device and receiving the customer footprint from the computing device in response to transmitting the customer information, also in a similar manner as described with reference to FIG. 13. As also shown, in response to receiving the customer information, processing system 16 transmits the customer footprint to EDD 10 (1404A). For example, processing system 16 may transmit the customer footprint to EDD 10 using any combination of wired and wireless communication protocols or interfaces previously described with reference to the customer information. In this manner, processing system 16 may acquire (e.g., receive), maintain (e.g., store), and distribute (e.g., transmit) to EDD 10 and/or one or more other EDDs one or more customer footprints associated with one or more customers and identifiable using corresponding customer information.

As shown in FIG. 14B, initially, processing system 16 receives a request for one or more industry-specific variables from EDD 10 (1402B). For example, the industry-specific variables may indicate values of metrics associated with the product, service, and/or place of business, as described herein. In general, the request may include a human-readable and/or machine-readable data structure, including any combination of character, numeric, symbolic, binary, hexadecimal, and other data representations, configured to cause processing system 16 to transmit the industry-specific variables to EDD 10. For instance, EDD 10 may transmit the request to processing system 16 upon receiving the customer information associated with customer 14 from PED 12 and retrieving the customer footprint associated with customer 14, as described with reference to FIG. 14A. For example, processing system 16 may receive the request from EDD 10 using any combination of wired and wireless communication protocols or interfaces previously described with reference to the customer information and customer footprint. In the example of FIG. 14B, processing system 16 may retrieve the industry-specific variables based on the request. For example, processing system 16 may retrieve the industry-specific variables from a local storage device and/or a remote storage device, in a similar manner as described with reference to FIG. 13. Additionally, or alternatively, processing system 16 may retrieve the industry-specific variables by transmitting the request to another computing device and receiving the industry-specific variables from the computing device in response to transmitting the request, also in a similar manner as described with reference to FIG. 13. As also shown, in response to receiving the request, EDD 10 transmits the industry-specific variables to EDD 10 (1404B). For example, processing system 16 may transmit the industry-specific variables to EDD 10 using any combination of wired and wireless communication protocols or interfaces previously described with reference to the customer information and customer footprint. In this manner, processing system 16 may acquire (e.g., receive), maintain (e.g., store), and distribute (e.g., transmit) to EDD 10 and/or one or more other EDDs one or more industry-specific variables associated with one or more industries (e.g., places of business and/or products or services thereof) and identifiable using corresponding requests.

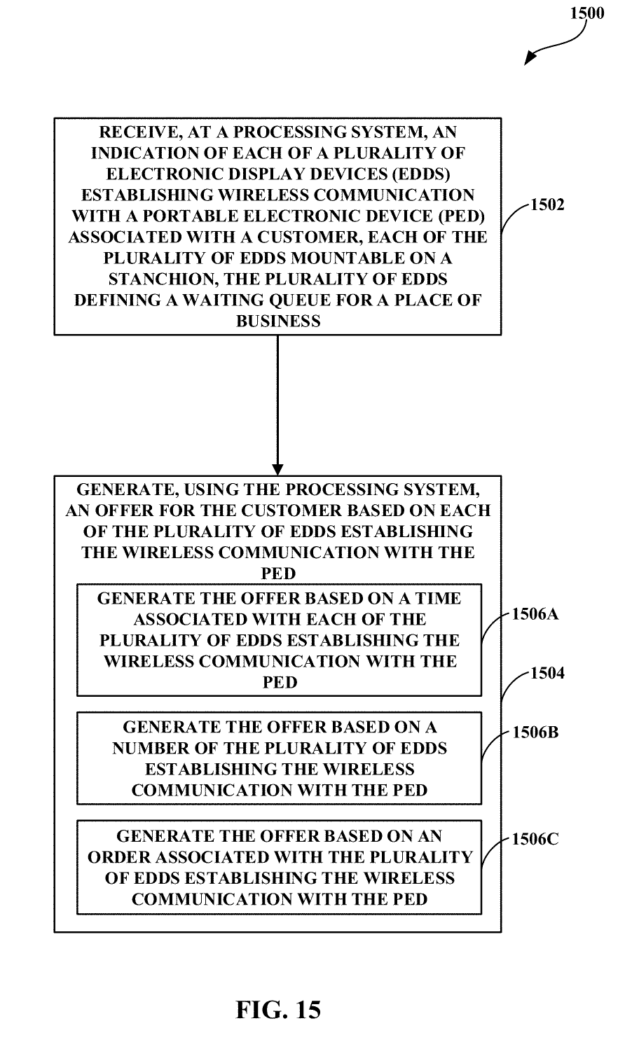

FIG. 15 depicts a flow diagram 1500, which illustrates an example interaction between multiples ones of EDD 10, which are referred to herein as a plurality of EDDs 20, and processing system 16, as also described with reference to FIGS. 1-12. In the example of FIG. 15, processing system 16 may be implemented using computing device 114 described with reference to FIG. 12. As shown in FIG. 15, initially, processing system 16 receives an indication of each of the plurality of EDDs 20 establishing wireless communication with PED 12 associated with customer 14 (1502). For example, processing system 16 may receive the indication of each of the plurality of EDDs 20 establishing the wireless communication with PED 12 from each of the plurality of EDDs 20. For instance, processing system 16 may receive an indication from each of the plurality of EDDs 20 upon the respective one of the plurality of EDDs 20 establishing the wireless communication with PED 12. In general, the indication may include a human-readable and/or machine-readable data structure, including any combination of character, numeric, symbolic, binary, hexadecimal, and other data representations. In this example, each of the plurality of EDDs 20 is mountable on a stanchion, the plurality of EDDs 20 is associated with a place of business providing a product and/or service, and the plurality of EDDs 20 defines a waiting queue for the place of business (1502), as described herein. For example, the plurality of EDDs 20 may be a subset of multiple EDDs that define the waiting queue for the place of business. In some examples, processing system 16 may be implemented as part of a user terminal (e.g., a desktop, laptop, or tablet computer) operated by a user associated with the place of business and located at the end of the waiting queue. Additionally, or alternatively, processing system 16 may be implemented as part of a remote server associated with the place of business and located at a remote location. As also shown, processing system 16 further generates an offer for customer 14 based on each of the plurality of EDDs 20 establishing the wireless communication with PED 12 (i.e., based on the indication) (1504). For example, the offer may include various offer types associated with the product, service, and/or place of business, as described herein. In some examples, processing system 16 generates the offer based on a time associated with each of the plurality of EDDs 20 establishing the wireless communication with PED 12 (1506A), as described with reference to FIG. 16A. In other examples, processing system 16 generates the offer based on a number of the plurality of EDDs 20 establishing the wireless communication with PED 12 (1506B), as described with reference to FIG. 16B. In still other examples, processing system 16 generates the offer based on an order associated with the plurality of EDDs 20 establishing the wireless communication with PED 12 (1506C), as described with reference to FIG. 16C. In these examples, the indication of each of the plurality of EDDs 20 establishing the wireless communication with PED 12 may include an indication of any of the time associated with each of the plurality of EDDs 20 establishing the wireless communication with PED 12, the number of the plurality of EDDs 20 establishing the wireless communication with PED 12, and the order associated with the plurality of EDDs 20 establishing the wireless communication with PED 12.

In the example of FIG. 15, at least one of the plurality of EDDs 20 may establish the wireless communication with PED 12 in a similar manner as described with reference to FIG. 13 (e.g., using any of Bluetooth, NFC, Wi-Fi, and another wireless communication protocol or interface). In some examples, at least one of the plurality of EDDs 20 may further receive customer information identifying customer 14 from PED 12 via the established wireless communication, retrieve a customer footprint associated with customer 14 based on the customer information, and retrieve one or more industry-specific variables, also in a similar manner as described with reference to FIG. 13. In these examples, processing system 16 may further generate the offer based on the customer footprint and based on the industry-specific variables retrieved by the at least one of the plurality of EDDs 20, also in a similar manner as described with reference to FIG. 13.

FIGS. 16A-16C depict flow diagrams 1600A-1600C, respectively, which illustrate additional example interactions between the plurality of EDDs 20 and processing system 16, as also described with reference to FIGS. 1-12. In particular, flow diagrams 1600A-1600C illustrate specific examples of the interactions described with reference to FIG. 15. As shown in FIG. 16A, initially, processing system 16 receives an indication of a time associated with each of the plurality of EDDs 20 establishing wireless communication with PED 12 associated with customer 14 (1602A). In general, the indication may include a human-readable and/or machine-readable data structure, including any combination of character, numeric, symbolic, binary, hexadecimal, and other data representations. In this example, each of the plurality of EDDs 20 is mountable on a stanchion, the plurality of EDDs 20 is associated with a place of business providing a product and/or service, and the plurality of EDDs 20 defines a waiting queue for the place of business (1602A), as described herein.

As further shown, processing system 16 then determines a difference between the times associated with at least two of the plurality of EDDs 20 establishing the wireless communication with PED 12 (1604A). In some examples, processing system 16 determines a difference between the times associated with two of the plurality of EDDs 20 establishing the wireless communication with PED 12 (1608A). For example, processing system 16 may determine a difference between the time associated with a first one of the plurality of EDDs 20 establishing the wireless communication with PED 12 and the time associated with a second, different one of the plurality of EDDs 20 establishing the wireless communication with PED 12. In a specific example, processing system 16 determines a difference between the times associated with first and last ones of the plurality of EDDs 20 to establish the wireless communication with PED 12 (1612A). For example, the first and last ones of the plurality of EDDs 20 may be first and last, respectively, temporally and/or sequentially to establish the wireless communication with PED 12 among the plurality of EDDs 20. As described herein, the difference between the times associated with the two of the plurality of EDDs 20 establishing the wireless communication with PED 12 may indicate various parameters associated with customer 14 traversing the waiting queue. As one example, the difference may indicate an amount of time customer 14 uses to traverse at least a portion of the waiting queue. As another example, assuming an average speed of customer 14 is known, the difference may indicate a distance that customer 14 traverses through at least a portion of the waiting queue. As still another example, assuming a distance between the two of the plurality of EDDs 20 is known, the difference may indicate an average speed at which customer 14 traverses at least a portion of the waiting queue.

In other examples, processing system 16 determines a difference between the times associated with more than two of the plurality of EDDs 20 establishing the wireless communication with PED 12 (1610A). For example, processing system 16 may determine a first difference between the times associated with first two of the plurality of EDDs 20 establishing the wireless communication with PED 12. Processing system 16 may further determine a second difference between the times associated with second two of the plurality of EDDs 20 establishing the wireless communication with PED 12. In some examples, the first and second two of the plurality of EDDs 20 may include three adjacent ones of the plurality of EDDs 20 (e.g. the first and second two of the plurality of EDDs 20 may share a common EDD). In other examples, the first and second two of the plurality of EDDs 20 may include four distinct ones of the plurality of EDDs 20. Processing system 16 may then aggregate or otherwise combine the first and second differences. In general, processing system 16 may aggregate or combine the first and second differences using any combination of arithmetic (e.g., +, *, /, etc.), relational (e.g., >, >=, <, <=, etc.), and other operators. In some examples, processing system 16 may determine a difference between the first and second differences (e.g., an absolute difference via subtraction, a proportional difference via division, or an indication that the difference exists via a relational operator). In further examples, processing system 16 may determine whether the difference is positive or negative, otherwise referred to as a sign of the difference (e.g., whether the first difference is greater than the second difference or vice versa). In still further examples, processing system 16 may determine whether the difference is greater than a threshold difference (e.g., whether the difference has a sufficient magnitude). As described herein, these attributes of the difference may indicate various parameters associated with customer 14 traversing the waiting queue. As a specific example, in cases where each of the first and second two of the plurality of EDDs 20 are spaced an equal distance apart, the existence of the difference between the first and second differences, the sign of the difference, and/or the magnitude of the difference may indicate whether and to what degree customer 14 is traversing the waiting queue at an increasing or decreasing speed. In other examples, processing system 16 may determine an average, a sum, a product, or any other aggregation or combination, of the first and second differences. In still other examples, processing system 16 may aggregate or combine additional (e.g., third, fourth, fifth, etc.) differences in a similar manner as described with reference to the first and second differences.

As also shown, processing system 16 then generates an offer for customer 14 based on the difference between the times associated with at least two of the plurality of EDDs 20 establishing the wireless communication with PED 12 (1606A). For example, the offer may include various offer types associated with the product, service, and/or place of business, as described herein. In some examples, processing system 16 compares the difference to a threshold difference and generates the offer based on a result of comparing the difference to the threshold difference (1614A). For example, processing system 16 may retrieve the threshold difference from a local storage device and/or a remote storage device, in a similar manner as described with reference to FIG. 13. In some examples, the threshold difference may be specified by a user associated with the place of business (e.g., a user operating processing system 16, or a system operator located at a remote location). In this manner, processing system 16 may be configured to determine an amount of time, distance, and/or average speed associated with customer 14 traversing at least a portion of the waiting queue and/or whether customer 14 traverses at least a portion of the waiting queue at an increasing or decreasing speed (e.g., whether customer 14 accelerates or decelerates), and generate the offer based on this determination.

As shown in FIG. 16B, initially, processing system 16 receives an indication of a number of the plurality of EDDs 20 establishing wireless communication with PED 12 associated with customer 14 (1602B). In general, the indication may include a human-readable and/or machine-readable data structure, including any combination of character, numeric, symbolic, binary, hexadecimal, and other data representations. In this example, each of the plurality of EDDs 20 is mountable on a stanchion, the plurality of EDDs 20 is associated with a place of business providing a product and/or service, and the plurality of EDDs 20 defines a waiting queue for the place of business (1602B), as described herein. As also shown, processing system 16 then generates an offer for customer 14 based on the number (1604B). For example, the offer may include various offer types associated with the product, service, and/or place of business, as described herein. As described herein, the number may indicate various parameters associated with customer 14 traversing the waiting queue. As one example, in cases where each of the plurality of EDDs 20 is spaced an equal distance apart, the number may indicate a distance that customer 14 traverses through at least a portion of the waiting queue. As another example, assuming an average speed of customer 14 is known, the number may indicate an amount of time customer 14 uses to traverse at least a portion of the waiting queue. As still another example, assuming the difference between the times associated with the first and last ones of the plurality of EDDs 20 to establish the wireless communication with PED 12 is known, as described in greater detail below, the number may indicate an average speed at which customer 14 traverses at least a portion of the waiting queue. In some examples, processing system 16 compares the number to a threshold number and generates the offer based on a result of comparing the number to the threshold number (1606B). For example, processing system 16 may retrieve the threshold number from a local storage device and/or a remote storage device, in a similar manner as described with reference to FIG. 13. In some examples, the threshold number may be specified by a user associated with the place of business (e.g., a user operating processing system 16, or a system operator located at a remote location). In other examples, processing system 16 receives an indication of a time associated with each of the plurality of EDDs 20 establishing the wireless communication with PED 12, in a similar manner as described with reference to FIG. 16A, and generates the offer based on the number and based on the times (1608B). For example, processing system 16 may compare the number to the difference between the times associated with the first and last ones of the plurality of EDDs 20 to establish the wireless communication with PED 12, in a similar manner as described with reference to FIG. 16A, and generate the offer based on a result of comparing the number to the difference (1610B). In general, processing system 16 may compare the number and difference by aggregating or otherwise combining the number and differences using any arithmetic, relational, and/or other operators described herein. As a specific example, in cases where each of the plurality of EDDs 20 is spaced an equal distance apart, the number (e.g., indicating distance) divided by the difference (e.g., indicating time), or the difference divided by the number, may indicate an average speed at which customer 14 traverses at least a portion of the waiting queue. In this manner, processing system 16 may be configured to determine a distance, a time, and/or an average speed associated with customer 14 traversing at least a portion of the waiting queue, and generate the offer based on this determination.

As shown in FIG. 16C, initially, processing system 16 determines an order associated with the plurality of EDDs 20 establishing wireless communication with PED 12 associated with customer 14 (1602C). In this example, each of the plurality of EDDs 20 is mountable on a stanchion, the plurality of EDDs 20 is associated with a place of business providing a product and/or service, and the plurality of EDDs 20 defines a waiting queue for the place of business (1602C), as described herein. In some examples, processing system 16 receives an indication of the order (1606C). In other examples, processing system 16 receives an indication of a time associated with each of the plurality of EDDs 20 establishing the wireless communication with PED 12, in a similar manner as described with reference to FIG. 16A, and determines the order based on the times (1608C). For example, processing system 16 may determine a temporal and/or sequential order associated with the plurality of EDDs 20 establishing the wireless communication with PED 12 based on the times. As also shown, processing system 16 then generates an offer for customer 14 based on the order (1604C). For example, the offer may include various offer types associated with the product, service, and/or place of business, as described herein. As described herein, the order may indicate various parameters associated with customer 14 traversing the waiting queue. For instance, in some examples, processing system 16 compares the order to a reference order and generates the offer based on a result of comparing the order to the reference order (1610C). For example, the reference order may reflect a relative spatial arrangement of the plurality of EDDs 20 within the waiting queue and indicate a temporal and/or sequential order in which customers generally traverse, or should traverse, the waiting queue. For instance, processing system 16 may retrieve the reference order from a local storage device and/or a remote storage device, in a similar manner as described with reference to FIG. 13. In some examples, the reference order may be specified by a user associated with the place of business a user operating processing system 16, or a system operator located at a remote location). In some examples, processing system 16 receives an indication of the reference order (1612C). In other examples, processing system 16 receives one or more indications of times associated with the plurality of EDDs 20 establishing wireless communication with one or more PEDs associated with one or more customers and determines the reference order based on the times (1614C). In other words, processing system 16 may use historical data indicating times associated with the plurality of EDDs 20 establishing wireless communication with other PEDs (e.g., prior to PED 12 establishing the wireless communication with the plurality of EDDs 20) to determine the reference order. Stated another way, the times associated with the plurality of EDDs 20 establishing the wireless communication with the other PEDs may indicate the temporal and/or sequential order in which customers generally traverse the waiting queue defined by the plurality of EDDs 20. In still other examples, processing system 16 also updates the reference order based on the order (1616C). In other words, processing system 16 may use the order (e.g., retrieved, received, or determined using the times associated with the plurality of EDDs 20 establishing the wireless communication with PED 12) to update the reference order. For example, processing system 16 may update the reference order based on the order and e.g., one or more previously determined orders, upon determining that the reference order is sufficiently different than the order and, e.g., the previously determined orders, indicating that the relative spatial arrangement of the plurality of EDDs 20 in the waiting queue has changed from that reflected by the reference order. Thus, processing system 16 may be configured to dynamically update the reference order so that it reflects a current relative spatial arrangement of the plurality of EDDs 20 in the waiting queue. In general, each of the various indications described with reference to FIG. 16C may include a human-readable and/or machine-readable data structure, including any combination of character, numeric, symbolic, binary, hexadecimal, and other data representations. In this manner, processing system 16 may be configured to determine a temporal and/or sequential order in which customer 14 traverses at least a portion of the waiting queue, determine whether this order deviates from an expected reference order (e.g., if customer 14 moves out of order), and generate the offer based on this determination.

What has been described is a device, system, and various methods relating to a real-time EDD that is portable and mountable on a stanchion and that can provide immediate information that may be useful to a customer, thereby overcoming the limitations and disadvantages inherent in the related art. Various applications exist for the device, system, and methods described herein. As one example, using the disclosed techniques, customers waiting in waiting queues at a rental car facility can be informed of inclement weather and be offered upgrades to all-wheel-drive vehicles.

Although the techniques of the present disclosure have been described in considerable detail with reference to certain preferred versions thereof, other versions are possible. Therefore, the spirit and scope of the claims should not be limited to the description of the preferred versions contained herein.

All features disclosed in the specification, including the claims, abstract, and drawings, and all of the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is only one example of a generic series of equivalent or similar features.

Any element in a claim that does not explicitly state “means” for performing a specified function or “step” for performing a specified function should not be interpreted as a “means” or “step” clause as specified in 35 U.S.C. § 112.

The techniques disclosed herein may be implemented, at least in part, in hardware, software, firmware, or any combination thereof. For example, various aspects of the examples described herein may be implemented using one or more processors or processing units, including one or more microprocessors, microcontrollers, DSPs, ASICs, FPGAs, any other equivalent integrated or discrete logic devices or circuitry, or any combination of such components. In this disclosure, the terms “processor” and “processing unit” may generally refer to any of the logic devices or circuitry described above, alone or in combination with other logic devices or circuitry, or to any other equivalent logic devices or circuitry. Furthermore, such hardware, software, and/or firmware may be implemented within a common device, or within separate devices, to perform the techniques described herein. In addition, any of the above-described components, devices, and modules may be implemented together or separately as discrete but interoperable logic devices or circuitry. Illustrations of the various features of these techniques using components, devices, and modules are intended to draw attention to different functional aspects of the techniques. They do not necessarily imply that any such elements are implemented by separate hardware, software, and/or firmware components. Instead, the functionality associated with one or more of the components, devices, and modules may be implemented using separate or integrated hardware, software, and/or firmware components.

Additionally, the techniques described herein may be embodied in a tangible (e.g., non-transitory) computer-readable storage medium (e.g., a memory component) encoded with computer-readable instructions. For example, the instructions may cause one or more processors or processing units (e.g., included as part of one or more computing devices) to implement one or more aspects of the techniques described herein by causing the processors or processing units to execute the instructions. In this context, the tangible computer-readable storage medium may include any of cache memory, RAM, ROM, PROM, EPROM, EEPROM, flash memory, SSD drives, any magnetic or optical computer-readable storage media, such as floppy disks, magnetic tape, HDDs, and CD-ROM or digital versatile disc (DVD) ROMs (DVD-ROMs), as well as any other computer-readable storage media. In some examples, the tangible computer-readable storage medium may include non-transitory storage media, which may indicate that the storage media are not embodied in a carrier wave or a propagated signal. Nevertheless, a non-transitory computer-readable storage medium consistent with these techniques may store data that can change over time, e.g., such as in the case of RAM or cache memory devices.

Various examples have been described in detail above. These, as well as numerous other examples, are within the scope of the following claims.

What is claimed is:

1. A method for providing real-time information to a customer via an electronic display device (EDD) mountable on a stanchion, the method comprising:
establishing, using the EDD, wireless communication with a portable electronic device (PED) associated with the customer;
receiving, at the EDD, customer information identifying the customer from the PED via the established wireless communication;
retrieving, using the EDD, a customer footprint associated with the customer based on the customer information;
retrieving, using the EDD, one or more industry-specific variables; and
generating, using the EDD, an offer for the customer based on the customer footprint and based on the one or more industry-specific variables.

2. The method of claim 1, wherein the EDD is associated with a place of business providing one or more of a product and a service, and wherein the customer information indicates user credentials associated with the customer for the place of business.

3. The method of claim 2, wherein the user credentials comprise user log-in credentials associated with the customer for an application (app) associated with the place of business.

4. The method of claim 1, wherein the EDD is associated with a place of business providing one or more of a product and a service, and wherein the customer footprint indicates previous activity associated with the one or more of the product and service by the customer.

5. The method of claim 4, wherein the previous activity comprises previous activity associated with the one or more of the product and service by the customer within an application (app) associated with the place of business.

6. The method of claim 1, wherein the EDD is associated with a place of business providing one or more of a product and a service, and wherein the one or more industry-specific variables comprise one or more values of one or more metrics associated with the one or more of the product and service.

7. The method of claim 1, wherein the EDD is associated with a place of business providing one or more of a product and a service, and wherein retrieving the customer footprint based on the customer information comprises:
generating, using the EDD based on the customer information, a request configured to cause the PED to extract the customer footprint from an application (app) associated with the place of business;
transmitting, using the EDD, the request to the PED via the established wireless communication; and
receiving, at the EDD, the customer footprint from the PED via the established wireless communication in response to transmitting the request.

8. The method of claim 1, further comprising determining, using the EDD, a time associated with the EDD establishing the wireless communication with the PED, wherein generating the offer comprises generating the offer based on the time associated with the EDD establishing the wireless communication with the PED.

9. The method of claim 1, wherein a plurality of EDDs each mountable on a stanchion, including the EDD, is associated with a place of business providing one or more of a product and a service and define a waiting queue for the place of business, the method further comprising determining, using the EDD, a time associated with each of multiple ones of the plurality of EDDs establishing wireless communication with the PED, wherein generating the offer comprises generating the offer based on the time associated with each of the multiple ones of the plurality of EDDs establishing the wireless communication with the PED.

10. The method of claim 1, wherein a plurality of EDDs each mountable on a stanchion, including the EDD, is associated with a place of business providing one or more of a product and a service and define a waiting queue for the place of business, the method further comprising determining, using the EDD, a number of the plurality of EDDs establishing wireless communication with the PED, wherein generating the offer comprises generating the offer based on the number.

11. The method of claim 1, wherein a plurality of EDDs each mountable on a stanchion, including the EDD, is associated with a place of business providing one or more of a product and a service and define a waiting queue for the place of business, the method further comprising determining, using the EDD, an order associated with multiple ones of the plurality of EDDs establishing wireless communication with the PED, wherein generating the offer comprises generating the offer based on the order.

12. The method of claim 1, wherein generating the offer comprises:
selecting, using the EDD, one of a plurality of fragrances included in the EDD based on one or more of the customer footprint and the one or more industry-specific variables; and
releasing, using the EDD, the one of the plurality of fragrances proximate to the EDD.

13. A method for providing real-time information to a customer, the method comprising:
receiving, at a computing device, an indication of each of a plurality of electronic display devices (EDDs) establishing wireless communication with a portable electronic device (PED) associated with the customer, wherein each of the plurality of EDDs is mountable on a stanchion, wherein the plurality of EDDs is associated with a place of business providing one or more of a product and a service, and wherein the plurality of EDDs defines a waiting queue for the place of business; and
generating, using the computing device, an offer for the customer based on each of the plurality of EDDs establishing the wireless communication with the PED.

14. The method of claim 13, wherein generating the offer based on each of the plurality of EDDs establishing the wireless communication with the PED comprises:
determining, using the computing device, a time associated with each of the plurality of EDDs establishing the wireless communication with the PED; and
generating, using the computing device, the offer based on the time associated with each of the plurality of EDDs establishing the wireless communication with the PED.

15. The method of claim 14, wherein generating the offer based on the time associated with each of the plurality of EDDs establishing the wireless communication with the PED comprises:
determining, using the computing device, a difference between the time associated with a first one of the plurality of EDDs establishing the wireless communication with the PED and the time associated with a second one of the plurality of EDDs establishing the wireless communication with the PED, wherein the first and second ones of the plurality of EDDs are different; and
generating, using the computing device, the offer based on the difference.

16. The method of claim 15, wherein the first one of the plurality of EDDs is first among the plurality of EDDs to establish the wireless communication with the PED, and wherein the second one of the plurality of EDDs is last among the plurality of EDDs to establish the wireless communication with the PED.

17. The method of claim 13, wherein generating the offer based on each of the plurality of EDDs establishing the wireless communication with the PED comprises:
determining, using the computing device, a number of the plurality of EDDs establishing the wireless communication with the PED; and
generating, using the computing device, the offer based on the number.

18. The method of claim 13, wherein generating the offer based on each of the plurality of EDDs establishing the wireless communication with the PED comprises:
determining, using the computing device, an order associated with the plurality of EDDs establishing the wireless communication with the PED; and
generating, using the computing device, the offer based on the order.

19. The method of claim 18, wherein generating the offer based on the order associated with the plurality of EDDs establishing the wireless communication with the PED comprises:
receiving, at the computing device, one or more indications of times associated with the plurality of EDDs establishing wireless communication with one or more PEDs associated with one or more customers;
determining, using the computing device, a reference order based on the times;
comparing, using the computing device, the order to the reference order; and
generating, using the computing device, the offer based on a result of comparing the order to the reference order.

20. The method of claim 13, further comprising:
receiving, at the computing device, customer information identifying the customer;
retrieving, using the computing device, a customer footprint associated with the customer based on the customer information; and
retrieving, using the computing device, one or more industry-specific variables,
wherein generating the offer comprises generating the offer based on the customer footprint and based on the industry-specific variables.
